(19) United States
(12) Patent Application Publication
(10) Pub. No.: US 2026/0334528 A1
(43) Pub. Date: Oct. 29, 2026

(54) ORAL PRODUCTS AND METHODS OF FORMING THE SAME

(71) Applicant: Altria Client Services LLC, Richmond, VA (US)

(72) Inventors: Tanmay DESAI, Henrico, VA (US); Will A. HAYES, Chester, VA (US)

(73) Assignee: Altria Client Services LLC, Richmond, VA (US)

(21) Appl. No.: 19/661,796

(22) Filed: Apr. 29, 2026

Related U.S. Application Data
(60) Provisional application No. 63/796,617, filed on Apr. 29, 2025.

(51) Int. Cl. A24B 15/32; A24B 13/00; A24F 23/02

(52) U.S. Cl. CPC A24B 15/32; A24B 13/00; A24F 23/02

(57) ABSTRACT

Methods for forming oral products include contacting a liquid to one or more surfaces of a substrate in a fluidized bed reactor, where the liquid includes a binder and a flavorant, and drying the liquid in the fluidized bed reactor to form one or more flexible, solid layers, where the one or more flexible, solid layers has a moisture content of less than or equal to about 10 weight percent.

### CROSS-REFERENCE TO RELATED APPLICATION

This application claims the benefit of U.S. Provisional Application No. 63/796,617, filed on Apr. 29, 2025, the entire disclosure of which is incorporated herein by reference in its entirety.

### BACKGROUND

### Field

The present disclosure relates to oral products and to methods of using and forming the same.

### Description of Related Art

Oral nicotine products are available in a variety of formats, including, for example, gums, sprays, lozenges, dissolvable tablets, non-dissolvable chews, films, gels, capsules, sticks (e.g., coated wooden dowels and/or singular dissolvable sticks), and pouches (e.g., containing fibers or granules). Oral products may have selected nicotine levels to create familiar experiences for adult tobacco consumers.

### SUMMARY

At least one example embodiment relates to a method for forming an oral product.

In at least one example embodiment, the method may include contacting a liquid to one or more surfaces of a substrate in a fluidized bed reactor, where the liquid include a binder and a flavorant, and drying the liquid in the fluidized bed reactor to form one or more flexible, solid layers, where the one or more flexible, solid layers have a moisture content of less than or equal to about 10 weight percent.

In at least one example embodiment, at least a portion of the drying may occur concurrent with the contacting.

In at least one example embodiment, the liquid may include greater than or equal to about 0.1 weight % to less than or equal to about 35 weight % of the binder.

In at least one example embodiment, the binder may include pectin, gelatin, sodium alginate, maltodextrin, pullulan, xanthan, gum acacia, hydroxypropylmethyl cellulose, methyl cellulose, sodium carboxy methyl cellulose, hydroxypropyl cellulose, hydroxyethyl cellulose, polyethylene oxide, polyvinyl alcohol, polyvinyl pyrrolidone, polyvinyl caprolactam-polyvinyl acetate-polyethylene glycol graft co-polymer, or any combination thereof.

In at least one example embodiment, the binder may include hydroxy propyl methyl cellulose.

In at least one example embodiment, the liquid may include greater than or equal to about 0.1 weight % to less than or equal to about 50 weight % of the flavorant.

In at least one example embodiment, the flavorant may include a fruit flavorant, a liquor or liqueur flavorant, a mint flavorant, a floral flavorant, a spice, an herb, or any combination thereof.

In at least one example embodiment, the flavorant may include bergamot, berry, cherry, lemon, orange, bourbon, cognac, scotch, whiskey, Japanese mint, menthol, peppermint, spearmint, wintergreen, mint oils from a species of genus Mentha, geranium, lavender, rose, anise, apium graveolens, caraway, cardamom, cascarilla, cassia, cinnamon, chamomile, clove, cocoa, coffee, coriander, fennel, ginger, jasmine, licorice, nutmeg, pimenta, sage, sandalwood vanilla, ylang-ylang, honey essence, or any combination thereof.

In at least one example embodiment, the flavorant may include peppermint.

In at least one example embodiment, the liquid may further include a plasticizer.

In at least one example embodiment, the liquid may include greater than or equal to about 0.1 weight % to less than or equal to about 15 weight % of the plasticizer.

In at least one example embodiment, the plasticizer may include polyethylene glycol, a triglyceride, triacetin, propylene glycol, glycerin, vegetable oil, a phthalate, an ester of a polycarboxylic acid with a linear or branched aliphatic alcohol of moderate chain length, or any combination thereof.

In at least one example embodiment, the plasticizer may include polyethylene glycol.

In at least one example embodiment, the method may further include preparing the liquid by contacting the binder and the flavorant to a carrier.

In at least one example embodiment, the carrier may include water, ethanol, methanol, acetone, propylene glycol, or any combination thereof.

In at least one example embodiment, the substrate may include paper.

In at least one example embodiment, the substrate may be fully dissolvable in an aqueous solution.

In at least one example embodiment, the substrate may include polyurethane fibers.

In at least one example embodiment, the substrate may be nonwoven.

In at least one example embodiment, the substrate may include a mesh.

In at least one example embodiment, the oral product may include an oral pouch product and the substrate may be incorporated into or may define the oral pouch product.

In at least one example embodiment, the oral pouch product may support a filler.

In at least one example embodiment, the oral pouch product may encase the filler.

In at least one example embodiment, the flavorant may be a first flavorant and the filler may include a second flavorant, where the first and second flavorants are the same.

In at least one example embodiment, the flavorant may be a first flavorant and the filler may include a second flavorant, where the first and second flavorants are different.

In at least one example embodiment, the binder may be a first binder and the filler may include a second binder, where the first and second binders are the same.

In at least one example embodiment, the binder may be a first binder and the filler may include a second binder, where the first and second binders are different.

In at least one example embodiment, the liquid may further include a plasticizer.

In at least one example embodiment, the plasticizer may be a first plasticizer and the filler may include a second plasticizer, where the first and second plasticizers are the same.

In at least one example embodiment, the plasticizer may be a first plasticizer and the filler may include a second plasticizer, where the first and second plasticizers are different.

In at least one example embodiment, the filler may include nicotine.

In at least one example embodiment, the filler may include tobacco.

In at least one example embodiment, the filler may include less than or equal to about 5 weight percent of the tobacco.

In at least one example embodiment, the method may further include cutting the substrate to a desired shape and size for the oral product.

In at least one example embodiment, the cutting may occur prior to the contacting.

In at least one example embodiment, the cutting may occur after the contacting.

In at least one example embodiment, the substrate may define one or more cavities, and the method may further include filling the one or more cavities.

In at least one example embodiment, the filling of the one or more cavities may occur before the contacting.

In at least one example embodiment, the filling of the one or more cavities may occur after the contacting.

In at least one example embodiment, the method may further include folding the substrate, sealing the substrate, or a combination of folding and sealing the substrate to define the one or more cavities.

In at least one example embodiment, the folding of the substrate, the sealing of the substrate, or the combination of folding and sealing of the substrate may occur before the contacting.

In at least one example embodiment, the folding of the substrate, the sealing of the substrate, or the combination of folding and sealing of the substrate may occur after the contacting.

In at least one example embodiment, air flow in the fluidized bed reactor during the contacting may be greater than or equal to about 250 rpm to less than or equal to about 290 rpm.

In at least one example embodiment, a first inlet air temperature during the contacting may be greater than or equal to about 50 °C to less than or equal to about 70 °C.

In at least one example embodiment, a second inlet air temperature during at least a portion of the drying may be greater than or equal to about 35 °C to less than or equal to about 70 °C.

In at least one example embodiment, the contacting may occur for a first time period.

In at least one example embodiment, the first time period may be greater than or equal to about 5 minutes to less than or equal to about 15 minutes.

In at least one example embodiment, the drying may occur for a second time period beyond the first time period.

In at least one example embodiment, the second time period may be greater than or equal to about 2 minutes to less than or equal to about 15 minutes.

In at least one example embodiment, the contacting may include spraying the liquid.

In at least one example embodiment, a spray rate during the contacting may be greater than or equal to about 0.1 g/min to less than or equal to about 3 g/min.

In at least one example embodiment, an atomization air pressure during the contacting may be greater than or equal to about 68.9 kPa to less than or equal to about 172.3 kPa.

In at least one example embodiment, the method may further include introducing the liquid into the fluidized bed reactor.

In at least one example embodiment, the method may further include introducing the substrate into the fluidized bed reactor.

In at least one example embodiment, the method may further include heating the substrate prior to the contacting.

In at least one example embodiment, the substrate may be heated to a temperature greater than or equal to about 40 °C to less than or equal to about 50 °C.

In at least one example embodiment, a water content of the oral product may range from about 1 weight percent to about 50 weight percent.

In at least one example embodiment, the water content may range from about 1 weight percent to about 10 weight percent.

In at least one example embodiment, the water content may range from about 10 weight percent to about 20 weight percent.

In at least one example embodiment, the water content may be greater than about 20 weight percent.

In at least one example embodiment, the water content may be greater than about 30 weight percent.

At least one example embodiment relates to an oral product including one or more flexible, solid layers.

In at least one example embodiment, the oral product may support a filler.

In at least one example embodiment, the filler may include nicotine.

In at least one example embodiment, the filler may include tobacco.

In at least one example embodiment, the filler may include less than or equal to about 5 weight percent of the tobacco.

In at least one example embodiment, a water content of the oral product may range from about 1 weight percent to about 50 weight percent.

In at least one example embodiment, the water content may range from about 1 weight percent to about 10 weight percent.

In at least one example embodiment, the water content may range from about 10 weight percent to about 20 weight percent.

In at least one example embodiment, the water content may be greater than about 20 weight percent.

In at least one example embodiment, the water content may be greater than about 30 weight percent.

At least one example embodiment relates to an oral pouch product including one or more flexible, solid layers.

In at least one example embodiment, the oral pouch product may support a filler.

In at least one example embodiment, the filler may include nicotine.

In at least one example embodiment, the filler may include tobacco.

In at least one example embodiment, the filler may include less than or equal to about 5 weight percent of the tobacco.

In at least one example embodiment, a water content of the oral pouch product may range from about 1 weight percent to about 50 weight percent.

In at least one example embodiment, the water content may range from about 1 weight percent to about 10 weight percent.

In at least one example embodiment, the water content may range from about 10 weight percent to about 20 weight percent.

In at least one example embodiment, the water content may be greater than about 20 weight percent.

In at least one example embodiment, the water content may be greater than about 30 weight percent.

In at least one example embodiment, the filler may include an alkaloid.

In at least one example embodiment, the filler may include nicotine.

In at least one example embodiment, the nicotine may include tobacco-derived nicotine.

In at least one example embodiment, the nicotine may include synthetic nicotine.

In at least one example embodiment, the nicotine may be in the form of a nicotine salt.

In at least one example embodiment, the nicotine may include free-base nicotine.

In at least one example embodiment, the nicotine may be in the form of a nicotine ion-exchange resin.

In at least one example embodiment, the filler may include the nicotine in an amount ranging from 1 milligram to 12 milligrams.

In at least one example embodiment, the filler may further include an antioxidant.

In at least one example embodiment, the filling material may further include an oil, and at least a portion of the nicotine may be dissolved in the oil.

In at least one example embodiment, the oil may include a triglyceride.

In at least one example embodiment, the filler may further include a solid carrier material mixed with the nicotine and the oil.

At least one example embodiments relates to another method for forming an oral product.

In at least one example embodiment, the method may include contacting a liquid to one or more surfaces of a substrate in a fluidized bed reactor, the liquid including a binder and a flavorant. The method may also include drying the liquid in the fluidized bed reactor to form one or more flexible, solid layers. The one or more flexible, solid layers may have a moisture content of less than or equal to about 10 weight percent.

In at least one example embodiment, at least a portion of the drying may occur concurrent with the contacting.

In at least one example embodiment, the liquid may include greater than or equal to about 0.1 weight % to less than or equal to about 35 weight % of the binder, greater than or equal to about 0.1 weight % to less than or equal to about 50 weight % of the flavorant, or a combination thereof.

In at least one example embodiment, the liquid may further include greater than or equal to about 0.1 weight % to less than or equal to about 15 weight % of a plasticizer.

In at least one example embodiment, the method may further include preparing the liquid by contacting the binder and the flavorant to a carrier.

In at least one example embodiment, the substrate may be fully dissolvable in an aqueous solution.

In at least one example embodiment, the oral product may include an oral pouch product, and the substrate may be incorporated into or defines the oral pouch product.

In at least one example embodiment, the oral pouch product may support a filler.

In at least one example embodiment, the flavorant may be a first flavorant, and the filler may include a second flavorant. The second flavorant may be the same as or different from the first flavorant.

In at least one example embodiment, the binder may be a first binder, and the filler may include a second binder The second binder may be the same as or different from the first binder.

In at least one example embodiment, the liquid may further include a first plasticizer, and the filler may include a second plasticizer. The second plasticizer may be the same as or different from the first plasticizer.

In at least one example embodiment, the method may further include cutting the substrate to a desired shape and size for the oral product.

In at least one example embodiment, the substrate may define one or more cavities, and the method may further include filling the one or more cavities.

In at least one example embodiment, the method may further include folding the substrate, sealing the substrate, or a combination of folding and sealing the substrate to define the one or more cavities.

In at least one example embodiment, air flow in the fluidized bed reactor during the contacting may be greater than or equal to about 250 rpm to less than or equal to about 290 rpm, and a first inlet air temperature during the contacting may be greater than or equal to about 50 °C to less than or equal to about 70 °C.

In at least one example embodiment, a second inlet air temperature during at least a portion of the drying may be greater than or equal to about 35 °C to less than or equal to about 70 °C.

In at least one example embodiment, the contacting may include spraying the liquid, a spray rate during the contacting being greater than or equal to about 0.1 g/min to less than or equal to about 3 g/min.

In at least one example embodiment, an atomization air pressure during the contacting may be greater than or equal to about 68.9 kPa to less than or equal to about 172.3 kPa.

In at least one example embodiment, the method may further include at least one of: introducing the liquid into the fluidized bed reactor; and introducing the substrate into the fluidized bed reactor.

In at least one example embodiment, the method may further include heating the substrate to a temperature greater than or equal to about 40 °C to less than or equal to about 50 °C prior to the contacting.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1A is a perspective view of an example oral pouch product in accordance with at least one example embodiment.

FIG. 1B is a cross-sectional view of the oral pouch product taken along line I-I of FIG. 1A.

FIG. 2A is a perspective view of another example oral pouch product in accordance with at least one example embodiment.

FIG. 2B is a cross-sectional view of the oral pouch product along line II-II of FIG. 2A.

FIG. 2C is a cross-sectional view of the oral pouch product along line III-III of FIG. 2A.

FIG. 3A is a side view of another example oral pouch product in accordance with at least one example embodiment.

FIG. 3B is a cross-sectional view along line VIII-VIII of the oral pouch product of FIG. 3A.

FIG. 4 is a flowchart illustrating an example method for preparing an oral product in accordance with at least one example embodiment.

FIG. 5 is a flowchart illustrating another example method for preparing an oral product in accordance with at least one example embodiment.

FIG. 6 is a schematic illustrating an example fluidized bed reactor for use in the preparation of an oral product in accordance with at least one example embodiment.

### DETAILED DESCRIPTION OF EXAMPLE EMBODIMENTS

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, component, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” specify the presence of stated features, integers, steps, operations, and/or elements, but do not preclude the presence or addition of one or more other features, integers, steps, operations, elements, and/or groups thereof.

When the terms “about” or “substantially” are used in this specification in connection with a numerical value, it is intended that the associated numerical value includes a manufacturing or operational tolerance (e.g., ±10%) around the stated numerical value. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

The present application generally relates to oral products and to methods of using and forming the same. The oral product may be an oral tobacco product, an oral non-tobacco product, an oral cannabis product, or any combination thereof. The oral product may be in a form of loose material (e.g., loose cellulosic material), shaped material (e.g., plugs or twists), pouched material, tablets, lozenges, chews, gums, films, any other oral product, or any combination thereof.

In at least one example embodiment, the oral product may include chewing tobacco, snus, moist snuff tobacco, dry snuff tobacco, other smokeless tobacco and non-tobacco products for oral consumption, or any combination thereof.

Where the oral product is an oral tobacco product including smokeless tobacco product, the smokeless tobacco product may include tobacco that is whole, shredded, cut, granulated, reconstituted, cured, aged, fermented, pasteurized, or otherwise processed. Tobacco may be present as whole or portions of leaves, flowers, roots, stems, extracts (e.g., nicotine), or any combination thereof.

In at least one example embodiment, the oral product may include a tobacco extract, such as a tobacco-derived nicotine extract, a synthetic nicotine, or a combination of a tobacco-derived nicotine extract and a synthetic nicotine. The nicotine may be in the form of liquid nicotine, a nicotine salt, or a nicotine complex (e.g., nicotine polacrilex). The nicotine salt may include nitrate, monotartrate, bitartrate, bitartrate dihydrate, salicylate, sulfate or bisulfate, phosphate or acid phosphate, acetate, lactate, succinate, maleate, fumarate, gluconate, saccharate, benzoate, methanesulfonate, hydrochloride, hydrobromide, hydroiodide, or any combination thereof.

In at least one example embodiment, the oral product may include the nicotine in an amount greater than or equal to about 0.1 milligram (e.g., greater than or equal to about 1 milligram, greater than or equal to about 2 milligrams, greater than or equal to about 4 milligrams, greater than or equal to about 6 milligrams, greater than or equal to about 8 milligrams, greater than or equal to about 10 milligrams, greater than or equal to about 12 milligrams, greater than or equal to about 14 milligrams, greater than or equal to about 16 milligrams, greater than or equal to about 18 milligrams, greater than or equal to about 20 milligrams, or greater than or equal to about 22 milligrams). In at least one example embodiment, the oral product may include the nicotine in an amount less than or equal to about 24 milligrams (e.g., less than or equal to about 22 milligrams, less than or equal to about 20 milligrams, less than or equal to about 18 milligrams, less than or equal to about 16 milligrams, less than or equal to about 14 milligrams, less than or equal to about 12 milligrams, less than or equal to about 10 milligrams, less than or equal to about 8 milligrams, less than or equal to about 6 milligrams, less than or equal to about 4 milligrams, less than or equal to about 2 milligrams, or less than or equal to about 1 milligram). In at least one example embodiment, the oral product may include the nicotine in an amount greater than or equal to about 0.1 milligram to less than or equal to about 24 milligrams (e.g., greater than or equal to about 0.1 to less than or equal to about 14 milligrams or greater than or equal to about 3 milligrams to less than or equal to about 8 milligrams).

In at least one example embodiment, the oral product may include the nicotine derivative or nicotine salt in an amount greater than or equal to about 20 milligrams (e.g., greater than or equal to about 22 milligrams, greater than or equal to about 24 milligrams, greater than or equal to about 26 milligrams, greater than or equal to about 28 milligrams, greater than or equal to about 30 milligrams, greater than or equal to about 32 milligrams, greater than or equal to about 34 milligrams, greater than or equal to about 36 milligrams, greater than or equal to about 38 milligrams, greater than or equal to about 40 milligrams, greater than or equal to about 42 milligrams, greater than or equal to about 44 milligrams, greater than or equal to about 46 milligrams, or greater than or equal to about 48 milligrams). In at least one example embodiment, the oral product may include the nicotine derivative or nicotine salt in an amount less than or equal to about 50 milligrams (e.g., less than or equal to about 48 milligrams, less than or equal to about 46 milligrams, less than or equal to about 44 milligrams, less than or equal to about 42 milligrams, less than or equal to about 40 milligrams, less than or equal to about 38 milligrams, less than or equal to about 36 milligrams, less than or equal to about 34 milligrams, less than or equal to about 32 milligrams, less than or equal to about 30 milligrams, less than or equal to about 28 milligrams, less than or equal to about 26 milligrams, or less than or equal to about 24 milligrams). In at least one example embodiment, the oral product may include the nicotine derivative or nicotine salt in an amount greater than or equal to about 20 milligrams to less than or equal to about 50 milligrams (e.g., greater than or equal to about 22 milligrams to less than or equal to about 48 milligrams, greater than or equal to about 24 milligrams to less than or equal to about 46 milligrams, greater than or equal to about 26 milligrams to less than or equal to about 44 milligrams, greater than or equal to about 28 milligrams to less than or equal to about 42 milligrams, greater than or equal to about 30 milligrams to less than or equal to about 40 milligrams, greater than or equal to about 32 milligrams to less than or equal to about 38 milligrams, or greater than or equal to about 34 milligrams to less than or equal to about 36 milligrams).

The oral product may include nicotine alone or in combination with a carrier (e.g., white snus), such as a cellulosic material. For example, in at least one example embodiment, the nicotine may be present in a mixture that includes a solid carrier material, a liquid carrier material, and nicotine. At least a portion of the nicotine may be dissolved in the liquid carrier material to form a diluted nicotine or a nicotine solution. The diluted nicotine may be combined or mixed with the solid carrier material.

In at least one example embodiment, the liquid carrier material may include a plasticizer, an oil, or any combination thereof. The oil may include for example, a monoglyceride, a diglyceride, a triglyceride, a vegetable oil, triacetin, a flavor oil, a fatty acid, or any combination thereof. In at least one example embodiment, the oil includes a triglyceride. The triglyceride may include short, medium, and/or long chain triglyceride(s). The nicotine may be liquid nicotine.

The solid carrier material may be an inert material that is in the form of particles, fibers, or a combination of particles and fibers. The solid carrier material may be porous. In at least one example embodiment, the carrier material may include a non-tobacco material. The carrier material may include, for example, a mouth-insoluble material, such as a cellulosic material, talc, silica, calcium carbonate, or any combination thereof.

In at least one example embodiment, the solid carrier material may include a cellulosic material. The cellulosic material may include a non-tobacco cellulosic material. The solid carrier material may include a chemically-treated cellulosic material, such as microcrystalline cellulose (MCC), carboxymethyl cellulose (CMC), hydroxypropyl methylcellulose (HPMC), hydroxypropyl cellulose (HPC), or any combination thereof. In at least one example embodiment, the cellulosic material may include a botanical, such as sugar beet, wood pulp, cotton, bran, citrus pulp, grass, willow, poplar, or any combination thereof. In at least one other example embodiment, the solid carrier material may include tobacco material (e.g., tobacco fibers having reduced or eliminated nicotine content, which may be referred to as “exhausted tobacco plant tissue or fibers”). In some example embodiments, the exhausted tobacco plant tissue or fibers can be treated to remove at least about 25 percent (e.g., at least 40 percent, at least 50 percent, at least 60 percent, at least 70 percent, at least 75 percent, at least 80 percent, at least 85 percent, at least 90 percent, or at least 95 percent) of the nicotine. For example, the tobacco plant tissue can be washed with water or another solvent to remove the nicotine.

In at least one example embodiment, the oral product may include cannabis, such as cannabis plant tissue, cannabis extracts, or a combination of cannabis plant tissue and cannabis extracts. The cannabis material may include, for example, leaf material, flower material, or a combination of leaf and flower material from one or more species of cannabis plants, cannabis extracts, or a combination of cannabis plants and extracts from the one or more species of cannabis plants. The one or more species of cannabis plants may include Cannabis sativa, Cannabis indica, Cannabis ruderalis, or any combination thereof. In at least one example embodiment, the cannabis may be in the form of fibers. In at least one example embodiment, the cannabis may include a cannabinoid, a terpene, a flavonoid, or any combination thereof. In at least one example embodiment, the cannabis material may be a cannabis-derived cannabis material, such as a cannabis-derived cannabinoid, a cannabis-derived terpene, a cannabis-derived flavonoid, or any combination thereof.

In at least one example embodiment, the oral product may include one or more elements or additives such as a mouth-stable polymer, a mouth-soluble polymer, a sweetener, an energizing agent, a soothing agent, a focusing agent, a plasticizer, a humectant, mouth-soluble or partially-soluble fibers (e.g., sugar beet fibers), an alkaloid, a mineral, a vitamin, a dietary supplement, a nutraceutical, a coloring agent, an amino acid, a chemesthetic agent, an antioxidant, a food-grade emulsifier (e.g., glycerol monostearate, propylene glycol monostearate, an acetylated monoglyceride, polysorbate, or any combination thereof), a pH modifier, a botanical (e.g., green tea), a tooth-whitening agent (e.g., sodium hexametaphosphate (SHMP)), a therapeutic agent, a processing aid, a stearate (e.g., magnesium and/or potassium), a wax, a stabilizer (e.g., ascorbic acid and monosterol citrate, butylated hydroxytoluene (BHT), or butylated hydroxyanisole (BHA)), a lubricant (e.g., sodium lauryl sulfate (SLS)), a disintegrating agent, a preservative (e.g., sodium benzoate), a filler, a flavorant, an effervescent (e.g., carbon dioxide embedded in a flavorant or a filling material), a flavor masking agent, a bitterness receptor site blocker, a receptor site enhancer, other additives, or any combination thereof. The oral product may include multiple additional elements. Additionally, a single element may belong to more than one of the categories above.

In at least one example embodiment, the additive may be included in the oral product in an amount greater than or equal to about 0.001 weight percent (e.g., greater than or equal to about 0.005 weight percent, greater than or equal to about 0.01 weight percent, greater than or equal to about 0.05 weight percent, greater than or equal to about 0.1 weight percent, greater than or equal to about 0.5 weight percent, greater than or equal to about 1 weight percent, greater than or equal to about 2 weight percent, greater than or equal to about 5 weight percent, greater than or equal to about 10 weight percent, greater than or equal to about 15 weight percent, greater than or equal to about 20 weight percent, greater than or equal to about 25 weight percent, greater than or equal to about 30 weight percent, greater than or equal to about 35 weight percent, or greater than or equal to about 40 weight percent). In at least one example embodiment, the additive may be present in an amount less than or equal to about 65 weight percent (e.g., less than or equal to about 60 weight percent, less than or equal to about 55 weight percent, less than or equal to about 50 weight percent, less than or equal to about 45 weight percent, less than or equal to about 40 weight percent, less than or equal to about 35 weight percent, less than or equal to about 30 weight percent, less than or equal to about 25 weight percent, less than or equal to about 20 weight percent, less than or equal to about 15 weight percent, less than or equal to about 10 weight percent, less than or equal to about 5 weight percent, less than or equal to about 1 weight percent, less than or equal to about 0.5 weight percent, less than or equal to about 0.1 weight percent, or less than or equal to about 0.01 weight percent). In at least one example embodiment, the additive may be included in the oral product in an amount ranging from about 0.001 weight percent to about 65 weight percent.

As used herein, “mouth-soluble” means that the polymer experiences significant degradation when exposed to saliva within an oral cavity of an adult consumer over a period of about four hours. In at least one example embodiment, the mouth-soluble polymer disintegrates when exposed to saliva having a normal human body temperature (i.e., 98.6 °F) for a period of less than or equal to about an hour (e.g., less than or equal to about 30 minutes, less than or equal to about 15 minutes, less than or equal to about 10 minutes, or less than or equal to about 5 minutes).

In at least one example embodiment, the oral product may be free of a mouth-soluble polymer. In at least one example embodiment, the oral product may include a mouth-soluble polymer. The mouth-soluble polymer may include, for example, a cellulosic polymer, a natural polymer, a seaweed-derived polymer, a microbial-derived polymer, an extract, an exudate, a synthetic polymer, or any combination thereof. Other useful mouth-soluble polymers are known in the art, for example, see Krochta et al., Food Technology (1997) at 51:61-74; Glicksman Food Hydrocolloids CRC 1982; Krochta Edible Coatings and Films to Improve Food Quality Technomic 1994; Industrial Gums Academic 1993; and/or Nussinovitch Water-Soluble Polymer Applications in Foods Blackwell Science 2003, the entire contents of which are hereby incorporated by reference.

In at least one example embodiment, the cellulosic polymer may include, for example, carboxymethyl cellulose (CMC), hydroxypropyl (HPC), hydroxyethyl cellulose (HEC), hydroxypropyl methylcellulose (HPMC), methyl cellulose (MC), or any combination thereof. In at least one example embodiment, the natural polymer may include, for example, a starch, a modified starch, konjac, collagen, inulin, soy protein, whey protein, casein, wheat gluten, or any combination thereof. In at least one example embodiment, the seaweed-derived polymer may include, for example, a carrageenan, an alginate, or a combination of a carrageenan and an alginate. In at least one example embodiment, the carrageenan may include, for example, kappa carrageenan, iota carrageenan, lambda carrageenan, or any combination thereof. In at least one example embodiment, the alginate may include, for example, propylene glycol alginate. In at least one example embodiment, the microbial-derived polymer may include, for example, xanthan, dextran, pullulan, curdlan, gellan, or any combination thereof. In at least one example embodiment, the extract may include, for example, locust bean gum, guar gum, tara gum, gum tragacanth, pectin (e.g., low methoxy and amidated), agar, zein, karaya, gelatin, psyllium seed, chitin, chitosan, or any combination thereof. In at least one example embodiment, the exudate may include, for example, gum acacia (arabic), shellac, or any combination thereof. In at least one example embodiment, the synthetic polymer may include, for example, polyvinyl pyrrolidone, polyethylene oxide, polyvinyl alcohol, or any combination thereof.

As used herein, “mouth-stable” means that the polymer does not appreciably dissolve or disintegrate when exposed to saliva at the normal human body temperature (i.e., 98.6 °F) over a period of about one hour. In at least one example embodiment, the mouth-stable polymer may be a biodegradable polymer that is configured to break down over a period of days, weeks, months, or years but does not appreciably break down when held in an oral cavity and exposed to saliva for a period of about one hour. In at least one example embodiment, the mouth-stable polymer may be stable within an oral cavity and exposed to saliva at the normal human body temperature for a period of greater than or equal to about 2 hours (e.g., greater than or equal to about 6 hours, greater than or equal to about 12 hours, greater than or equal to about 1 day, or greater than or equal to about 2 days). Accordingly, an oral product including a mouth-stable polymer according to at least one example embodiment may be configured to remain intact when placed in an adult consumer's mouth. After a period of time, the mouth-stable polymer and any other mouth-stable elements may be removed from the adult consumer's mouth and discarded.

The mouth-stable polymer may be biocompatible and biostable. The mouth-stable polymer may generally be recognized as safe and in compliance with applicable food-contact regulations by an appropriate regulatory agency (e.g., the U.S. Food and Drug Administration (FDA)). In at least one example embodiment, the mouth-stable polymer may have a flexural modulus of greater than or equal to about 5 MPa (e.g., greater than or equal to about 10 MPa) when tested according to ASTM Testing Method D790 or ISO 178 at 23 °C.

In at least one example embodiment, the oral product may be free of a mouth-stable polymer. In at least one example embodiment, the oral product may include a mouth-stable polymer. In at least one example embodiment, the mouth-stable polymer may include, for example, a polyurethane, a silicone, a polyester, a polyacrylate, a polyethylene, a polypropylene, a polyetheramide, a polystyrene, a polyvinyl alcohol, a polyvinyl acetate, a polyvinyl chloride, a polybutyl acetate, a butyl rubber, poly(styrene-ethylene-butylene-styrene) (SEBS), poly(styrene-butadiene-styrene) (SBS), poly(styrene-isoprene-styrene) (SIS), any copolymer thereof, or any combination thereof. In at least one example embodiment, the mouth-stable polymer may include a food-grade or medical-grade polymer, such as medical-grade polyurethane.

In at least one example embodiment, the mouth-stable polymer may include, for example, a thermoplastic polymer. The thermoplastic polymer may include a thermoplastic elastomer. In at least one example embodiment, the mouth-stable polymer may include a thermoplastic elastomer meeting the requirements of the FDA-modified ISO 10993, Part 1 “Biological Evaluation of Medical Devices” tests with human tissue contact time of 30 days or less. In at least one example embodiment, the mouth-stable polymer may have a shore Hardness of 50D or softer, a melt flow index of about 3 g/10 min at 200 °C/10 kg, a tensile strength of greater than or equal to about 10 MPa (using ISO 37), and/or an ultimate elongation of less than about 100% (using ISO 37).

In at least one example embodiment, the oral product may be free of a sweetener. In at least one example embodiment, the oral product may include a sweetener. In at least one example embodiment, the oral product may include an encapsulated sweetener. The sweetener may include, for example, a synthetic sweetener, a natural sweetener, or a combination of a synthetic sweetener and a natural sweetener.

The natural sweetener may include, for example, a sugar such as monosaccharide, a disaccharide, a polysaccharide, or any combination thereof. The natural sweetener may include, for example, sucrose, honey, a mixture of low-molecular-weight sugars excluding sucrose, glucose (i.e., grape sugar, corn sugar, dextrose), molasses, corn sweetener, glucose syrup (i.e., corn syrup), fructose (i.e., fruit sugar), lactose (i.e., milk sugar), maltose (i.e., malt sugar, maltobiose), sorghum syrup, fruit juice concentrate, or any combination thereof.

In at least one example embodiment, the sweetener may include a sugar alcohol. The sugar alcohol may include, for example, ethylene glycol, glycerol, erythritol, threitol, arabitol, xylitol, ribitol, mannitol, sorbitol, galactitol, fucitol, iditol, inositol, volemitol, isomalt, maltitol, lactitol, maltotriitol, maltotetraitol, polyglycitol, or any combination thereof. In at least one example embodiment, the sweetener may include a non-nutritive sweetener. The non-nutritive sweetener may include, for example, stevia, saccharin, aspartame, sucralose, acesulfame potassium, or any combination thereof.

As used herein, the term “nutraceuticals” refers to any ingredient in foods that has a beneficial effect on human health. Nutraceuticals include particular compounds and/or compositions isolated from natural food sources and genetically modified food sources. Suitable nutraceuticals include, without limitation, various phytonutrients derived from natural plants and genetically engineered plants. In at least one example embodiment, the oral product may be free of a nutraceutical. In at least one example embodiment, the oral product may include the nutraceutical.

In at least one example embodiment, the oral product may include the nutraceutical in an amount greater than or equal to about 0.1 weight percent (e.g., greater than or equal to about 0.5 weight percent, greater than or equal to about 1 weight percent, greater than or equal to about 1.5 weight percent, greater than or equal to about 2 weight percent, greater than or equal to about 2.5 weight percent, greater than or equal to about 3 weight percent, greater than or equal to about 3.5 weight percent, greater than or equal to about 4 weight percent, or greater than or equal to about 4.5 weight percent). In at least one example embodiment, the oral product may include the nutraceutical in an amount less than or equal to about 5 weight percent (e.g., less than or equal to about 4.5 weight percent, less than or equal to about 4 weight percent, less than or equal to about 3.5 weight percent, less than or equal to about 3 weight percent, less than or equal to about 2.5 weight percent, less than or equal to about 2 weight percent, less than or equal to about 1.5 weight percent, less than or equal to about 1 weight percent, or less than or equal to about 0.5 weight percent). In at least one example embodiment, the oral product may include the nutraceutical in an amount ranging from about 0.1 weight percent to about 5 weight percent.

In at least one example embodiment, the oral product may be free of an energizing agent. In at least one example embodiment, the oral product may include an energizing agent. The energizing agent may include, for example, caffeine, citicoline, taurine, glucaronalactone, guarana, vitamin B6, vitamin B12, or any combination thereof.

Caffeine, also known as 1,3,7-trimethylxanthine, is a white, odorless, bitter tasting substance. Caffeine occurs naturally in tea, coffee, and chocolate, and is commonly added to soft drinks, energy drinks and some foods. However, because of the bitter taste of caffeine, the flavor of drinks or foods having a relatively high caffeine content can be unappealing. Caffeine may include synthetic caffeine and/or natural caffeine, such as coffee bean-extracted caffeine.

In at least one example embodiment, the oral product may include the energizing agent (for example, the caffeine) in amount greater than or equal to about 10 milligrams (e.g., greater than or equal to about 25 milligrams, greater than or equal to about 50 milligrams, greater than or equal to about 75 milligrams, greater than or equal to about 100 milligrams, or greater than or equal to about 150 milligrams). In at least one example embodiment, the oral product may include the energizing agent (for example, the caffeine) in an amount less than or equal to about 200 milligrams (e.g., less than or equal to about 150 milligrams, less than or equal to about 100 milligrams, less than or equal to about 75 milligrams, less than or equal to about 50 milligrams, or less than or equal to about 25 milligrams). In at least one example embodiment, the oral product may include the energizing agent (for example, the caffeine) in an amount greater than or equal to about 10 milligrams to less than or equal to about 200 milligrams (e.g., greater than or equal to about 20 milligrams to less than or equal to about 180 milligrams, greater than or equal to about 30 milligrams to less than or equal to about 170 milligrams, greater than or equal to about 40 milligrams to less than or equal to about 160 milligrams, greater than or equal to about 50 milligrams to less than or equal to about 150 milligrams, greater than or equal to about 60 milligrams to less than or equal to about 140 milligrams, greater than or equal to about 70 milligrams to less than or equal to about 130 milligrams, greater than or equal to about 80 milligrams to less than or equal to about 120 milligrams, or greater than or equal to about 90 milligrams to less than or equal to about 110 milligrams).

In at least one example embodiment, the oral product may have a relatively high caffeine content so as to provide a consumer with a burst of energy. For example, the oral product may include the caffeine in amount greater than or equal to about 50 milligrams (e.g., greater than or equal to about 75 milligrams, greater than or equal to about 100 milligrams, or greater than or equal to about 150 milligrams). In at least one example embodiment, the oral product includes the caffeine in an amount less than or equal to about 200 milligrams (e.g., less than or equal to about 150 milligrams, less than or equal to about 100 milligrams, or less than or equal to about 75 milligrams). In at least one example embodiment, the oral product may include the caffeine in an amount ranging from about 50 milligrams to about 200 milligrams (e.g., ranging from about 60 milligrams to about 190 milligrams, ranging from about 70 milligrams to about 180 milligrams, ranging from about 80 milligrams to about 170 milligrams, ranging from about 90 milligrams to about 160 milligrams, ranging from about 100 milligrams to about 150 milligrams, or ranging from about 120 milligrams to about 140 milligrams).

In at least one example embodiment, the oral product may include other energizing ingredients (e.g., taurine, citicoline, guarana, or any combination thereof) in addition to the caffeine. The oral product may include the other energizing ingredients in an amount greater than or equal to about 0.1 weight percent (e.g., greater than or equal to about 0.5 weight percent, greater than or equal to about 1 weight percent, greater than or equal to about 1.5 weight percent, greater than or equal to about 2 weight percent, greater than or equal to about 2.5 weight percent, greater than or equal to about 3 weight percent, greater than or equal to about 3.5 weight percent, greater than or equal to about 4 weight percent, or greater than or equal to about 4.5 weight percent). The oral product may include the other energizing ingredients in an amount less than or equal to about 5 weight percent (e.g., less than or equal to about 4.5 weight percent, less than or equal to about 4 weight percent, less than or equal to about 3.5 weight percent, less than or equal to about 3 weight percent, less than or equal to about 2.5 weight percent, less than or equal to about 2 weight percent, less than or equal to about 1.5 weight percent, less than or equal to about 1 weight percent, or less than or equal to about 0.5 weight percent). The oral product may include the other energizing ingredients in an amount ranging from about 0.1 weight percent to about 5 weight percent.

As used herein, “soothing agents” are those selected to provide a soothing sensation to the throat and/or oral cavity of an adult consumer. In at least one example embodiment, the oral product may be free of a soothing agent. In at least one example embodiment, the oral product may include a soothing agent. theanine (e.g., L-theanine), melatonin, or both theanine and melatonin. Additionally, or alternatively, the soothing agent may include, for example only, chamomile, lavender, jasmine, soursop, cannabidiol, or any combination thereof. The soothing agent can be added as a flavorant and or aroma embedded in the product and/or the package.

In at least one example embodiment, the oral product may include the soothing agent in an amount greater than or equal to about 0.1 weight percent (e.g., greater than or equal to about 0.5 weight percent, greater than or equal to about 1 weight percent, greater than or equal to about 1.5 weight percent, greater than or equal to about 2 weight percent, greater than or equal to about 2.5 weight percent, greater than or equal to about 3 weight percent, greater than or equal to about 3.5 weight percent, greater than or equal to about 4 weight percent, or greater than or equal to about 4.5 weight percent). In at least one example embodiment, the oral product may include the soothing agent in an amount less than or equal to about 5 weight percent (e.g., less than or equal to about 4.5 weight percent, less than or equal to about 4 weight percent, less than or equal to about 3.5 weight percent, less than or equal to about 3 weight percent, less than or equal to about 2.5 weight percent, less than or equal to about 2 weight percent, less than or equal to about 1.5 weight percent, less than or equal to about 1 weight percent, or less than or equal to about 0.5 weight percent). In at least one example embodiment, the oral product may include the soothing agent in an amount greater than or equal to about 0.1 weight percent to less than or equal to about 5 weight percent (e.g., greater than or equal to about 0.5 weight percent to less than or equal to about 4.5 weight percent, greater than or equal to about 1 weight percent to less than or equal to about 4 weight percent, or greater than or equal to about 1.5 weight percent to less than or equal to about 3.5 weight percent).

In at least one example embodiment, the oral product may be free of a plasticizer. In at least one example embodiment, the oral product may include a plasticizer. The plasticizer may include, for example, polyethylene glycol, a monoglyceride, a diglyceride, a triglyceride (e.g., long, medium, and/or short chain), triacetin, propylene glycol, 1,3-propanediol, glycerin, vegetable oil, a phthalate, an ester of a polycarboxylic acid with a linear or branched aliphatic alcohol of moderate chain length, or any combination thereof. In at least one example embodiment, the plasticizer may be present in addition to triglycerides and/or other oils in the liquid mixture.

In at least one example embodiment, the oral product may be free of a humectant. In at least one example embodiment, the oral product may include a humectant. The humectant may include, for example, propylene glycol, glycerin, 1,3-propanediol, or any combination thereof. In at least one example embodiment, the oral product includes the humectant in an amount greater than or equal to about 0.01 weight percent (e.g., greater than or equal to about 0.05 weight percent, greater than or equal to about 0.1 weight percent, greater than or equal to about 0.5 weight percent, greater than or equal to about 1 weight percent, greater than or equal to about 1.5 weight percent, greater than or equal to about 2 weight percent, greater than or equal to about 3 weight percent, greater than or equal to about 5 weight percent, greater than or equal to about 7 weight percent, or greater than or equal to about 10 weight percent). The oral product may include the humectant in an amount less than or equal to about 15 weight percent (e.g., less than or equal to about 10 weight percent, less than or equal to about 7 weight percent, less than or equal to about 5 weight percent, less than or equal to about 3 weight percent, less than or equal to about 2 weight percent, less than or equal to about 1.5 weight percent, less than or equal to about 1 weight percent, less than or equal to about 0.5 weight percent, less than or equal to about 0.1 weight percent, or less than or equal to about 0.05 weight percent, less than or equal to about 10 weight percent). In at least one example embodiment, the oral product includes the humectant in an amount ranging from about 0.01 weight percent to 15 weight percent.

In at least one example embodiment, the oral product may include propylene glycol. In at least one example embodiment, the oral product may be free of propylene glycol or includes propylene glycol in an amount less than or equal to about 5 weight percent (e.g., less than or equal to about 4 weight percent, less than or equal to about 3 weight percent, less than or equal to about 2 weight percent, less than or equal to about 1 weight percent, less than or equal to about 0.5 weight percent, less than or equal to about 0.1 weight percent, or less than or equal to about 0.05 weight percent).

In at least one example embodiment, the oral product may include glycerin. In at least one example embodiment, the oral product may be free of glycerin or includes glycerin in an amount less than or equal to about 5 weight percent (e.g., less than or equal to about 4 weight percent, less than or equal to about 3 weight percent, less than or equal to about 2 weight percent, less than or equal to about 1 weight percent, less than or equal to about 0.5 weight percent, less than or equal to about 0.1 weight percent, or less than or equal to about 0.05 weight percent).

In at least one example embodiment, the oral product may be free of mouth-soluble fibers. In at least one example embodiment, the oral product may include mouth-soluble fibers. In at least one example embodiment, the mouth-soluble fibers may include maltodextrin, psyllium, starch, or any combination thereof. In at least one example embodiment, the mouth-soluble fibers may include soluble dietary fibers. In at least one example embodiment, the oral product may include partially-soluble fibers, such as sugar beet fibers.

In at least one example embodiment, the oral product may be free of minerals. In at least one example embodiment, the oral product may include a mineral. The mineral may be in addition to any that may be present due to the inclusion, for example, of fruits and/or vegetables. The mineral may include, for example, calcium, magnesium, phosphorus, iron, zinc, iodine, selenium, potassium, copper, manganese, molybdenum, chromium, and any combination thereof. The amount of minerals incorporated into the oral product can be varied according to the type of mineral and the intended adult consumer. The amount of minerals may be formulated to include an amount less than or equal to the recommendations of the United States Department of Agriculture Recommended Daily Allowances.

In at least one example embodiment, the oral product may be free of a focusing agent. In at least one example embodiment, the oral product may include a focusing agent. The focusing agent may include, for example, ginkgo biloba.

In at least one example embodiment, the oral product may be free of a sensate and/or chemesthesis agent. In at least one example embodiment, the oral product may include a sensate and/or chemesthesis agent. The sensate and/or chemesthesis agent may include mint, menthol, cinnamon, pepper, jambu, or any combination thereof. The sensate and/or chemesthesis agent may include any soothing, cooling, and/or warming agent. For example, in at least one example embodiment, the sensate and/or chemesthesis agent may include capsaicin, pipeline, alpha-hydroxy-sanshool, and (8)-gingerole, which may be selected so as to provide a warm, tingling or burning sensation. In other example embodiments, the sensate and/or chemesthesis agent may include menthol, menthyl lactate, WS-3 (N-Ethyl-p menthane-3-carboxamide), WS-23 (2-Isopropyl-N,2,3-trimethylbutyramide) and Evercool 180™ (available from Givaudan SA), which may be selected so as to provide a cooling sensation.

In at least one example embodiment, the oral product may include the sensate and/or chemesthesis agent in an amount greater than or equal to about 0.01 weight percent (e.g., greater than or equal to about 0.05 weight percent, greater than or equal to about 0.1 weight percent, greater than or equal to about 0.5 weight percent, greater than or equal to about 1 weight percent, greater than or equal to about 2 weight percent, greater than or equal to about 3 weight percent, or greater than or equal to about 4 weight percent). The oral product may include the sensate and/or chemesthesis agent in an amount less than or equal to about 5 weight percent (e.g., less than or equal to about 4 weight percent, less than or equal to about 3 weight percent, less than or equal to about 2 weight percent, less than or equal to about 1 weight percent, less than or equal to about 0.5 weight percent, less than or equal to about 0.1 weight percent, or less than or equal to about 0.05 weight percent). The sensate and/or chemesthesis agent may be included in an amount ranging from about 0.01 weight percent of the oral product to about 5 weight percent of the oral product.

In at least one example embodiment, the oral product may be free of vitamins. In at least one example embodiment, the oral product may include a vitamin and/or derivatives thereof. The vitamin may include, for example, vitamin C, vitamin B, vitamin E, magnesium, calcium, derivatives thereof, or any combination thereof. In at least one example embodiment, the oral product includes one or more vitamins in addition to any that may be present due to the inclusion, for example, of fruits and/or vegetables. The one or more additional vitamins may include, for example, vitamin A (retinol), vitamin D (cholecalciferol), vitamin E group, vitamin K group (phylloquinones and menaquinones), thiamine (vitamin Bl), riboflavin (vitamin B2), niacin, niacinamide, pyridoxine (vitamin B6 group), folic acid, choline, inositol, vitamin B12 (cobalamins), PABA (para aminobezoic acid), biotin, vitamin C (ascorbic acid), and any combination thereof. The amount of vitamins may be chosen so as to provide an amount less than or equal to the recommendations of the United States Department of Agriculture Recommended Daily Allowances.

In at least one example embodiment, the oral product may be free of an antioxidant. In at least one example embodiment, the oral product may include an antioxidant. The antioxidant may include, for example, ascorbyl palmitate, butylated hydroxytoluene (BHT), ascorbic acid, sodium ascorbate, monosterol citrate, tocopherols, propyl gallate, tertiary butylhydroquinone (TBHQ), butylated hydroxyanisole (BHA), Vitamin E, and any combination or derivative thereof. The presence of the antioxidant may help to limit the formation of nicotine-N-oxides.

In at least one example embodiment, the oral product may be free of an amino acid. In at least one example embodiment, the oral product may include an amino acid. Suitable amino acids include, without limitation, the eight essential amino acids that cannot be biosynthetically produced in humans, including valine, leucine, isoleucine, lysine, threonine, tryptophan, methionine, and phenylalanine. Examples of suitable amino acids include the non-essential amino acids including alanine, arginine, asparagine, aspartic acid, cysteine, glutamic acid, glutamine, glycine, histidine, proline, serine, and tyrosine.

In at least one example embodiment, the oral product may include the amino acid in an amount greater than or equal to about 0.1 weight percent (e.g., greater than or equal to about 0.5 weight percent, greater than or equal to about 1 weight percent, greater than or equal to about 1.5 weight percent, greater than or equal to about 2 weight percent, greater than or equal to about 2.5 weight percent, greater than or equal to about 3 weight percent, greater than or equal to about 3.5 weight percent, greater than or equal to about 4 weight percent, or greater than or equal to about 4.5 weight percent). In at least one example embodiment, the oral product may include the amino acid in an amount less than or equal to about 5 weight percent (e.g., less than or equal to about 4.5 weight percent, less than or equal to about 4 weight percent, less than or equal to about 3.5 weight percent, less than or equal to about 3 weight percent, less than or equal to about 2.5 weight percent, less than or equal to about 2 weight percent, less than or equal to about 1.5 weight percent, less than or equal to about 1 weight percent, or less than or equal to about 0.5 weight percent). In at least one example embodiment, the oral product may include the amino acid in an amount ranging from about 0.1 weight percent to about 5 weight percent.

In at least one example embodiment, the oral product may be free of a coloring agent. In at least one example embodiment, the oral product may include a coloring agent. The coloring agent may include a natural colorant, an artificial colorant, or any combination thereof.

In at least one example embodiment, the oral product may be free of a pH modifier. In at least one example embodiment, the oral product may include a pH modifier. The pH modifier may include, for example, ammonium carbonate, ammonium bicarbonate, ammonium hydroxide, calcium carbonate, potassium carbonate, potassium bicarbonate, potassium hydroxide, sodium carbonate, sodium bicarbonate, sodium hydroxide, or any combination thereof.

In at least one example embodiment, the oral product may include the pH modifier in an amount greater than or equal to about 0.01 weight percent (e.g., greater than or equal to about 0.05 weight percent, greater than or equal to about 0.1 weight percent, greater than or equal to about 0.5 weight percent, greater than or equal to about 1 weight percent). In at least one example embodiment, the oral product may include the pH modifier in an amount less than or equal to about 2 weight percent (e.g., less than or equal to about 1 weight percent, less than or equal to about 0.5 weight percent, less than or equal to about 0.1 weight percent, less than or equal to about 0.05 weight percent). In at least one example embodiment, the oral product may include the pH modifier in an amount ranging from about 0.01 weight percent to about 2 weight percent (e.g., ranging from about 0.05 weight percent to about 1.5 weight percent).

In at least one example embodiment, the oral product may be free of a wax. In at least one example embodiment, the oral product may include a wax. The wax may include, for example, paraffin, microcrystalline wax, or both paraffin and microcrystalline wax.

In at least one example embodiment, the oral product may be free of a filler. In at least one example embodiment, the oral product may include a filler. The filler may be configured to alter a texture or pliability of the oral product. The filler may include, for example, mouth-soluble elements, mouth-insoluble elements, or both mouth-soluble and mouth-insoluble elements. Mouth-soluble elements may be configured to dissolve or disintegrate when in an adult consumer's mouth so as to render the oral product more pliable. The filler may include, for example, dicalcium phosphate, calcium sulfate, a clay, silica, glass particles, glyceryl palmitostearate, sodium stearyl fumarate, talc, or any combination thereof. In at least one example embodiment, certain other compounds or elements or components, including, for example, mouth-soluble fibers, sweeteners, minerals, as described, may be classified as fillers. For example, in at least one example embodiment, cellulosic materials may be present in the oral product as fillers in addition to or as an alternative to being carriers for active ingredients, additives, and/or liquid ingredients.

In at least one example embodiment, the oral product may include the filler in an amount less than or equal to 20 weight percent (e.g., less than or equal to 15 weight percent, less than or equal to 10 weight percent, less than or equal to 9 weight percent, less than or equal to 8 weight percent, less than or equal to 7 weight percent, less than or equal to 6 weight percent, less than or equal to 5 weight percent, less than or equal to 4 weight percent, less than or equal to 3 weight percent, less than or equal to 2 weight percent, or less than or equal to 1 weight percent). In at least one example embodiment, the oral product may include the filler in an amount greater than or equal to about 0 weight percent (e.g., greater than or equal to about 1 weight percent, greater than or equal to about 2 weight percent, greater than or equal to about 3 weight percent, greater than or equal to about 4 weight percent, or greater than or equal to about 5 weight percent). In at least one example embodiment, the oral product may include the filler in an amount ranging from about 0 weight percent to about 8 weight percent (e.g., ranging from about 1 weight percent to about 7 weight percent, ranging from about 2 weight percent to about 6 weight percent, or ranging from about 3 weight percent to about 5 weight percent).

In at least one example embodiment, the oral product may be free of a flavorant. In at least one example embodiment, the oral product may include a flavorant. The flavorant may include a liquid flavorant, a solid flavorant, or a combination thereof. In at least one example embodiment, the oral product includes an encapsulated flavorant. The flavorant may be natural or artificial. The flavorant may include, for example, a fruit flavorant (e.g., bergamot, berry, cherry, lemon, and/or orange), a liquor or liqueur flavorant (e.g., bourbon, cognac, scotch, whiskey, and/or DRAMBUIE brand liqueur), a mint flavorant (e.g., Japanese mint, menthol, peppermint, spearmint, wintergreen, and/or mint oils from a species of the genus Mentha), a floral flavorant (e.g., geranium, lavender, and/or rose), a spice, an herb, or another botanical or botanical-derived flavorant (e.g., anise, apium graveolens, caraway, cardamom, cascarilla, cassia, cinnamon, chamomile, clove, cocoa, coffee, coriander, fennel, ginger, jasmine, licorice, nutmeg, pimento, sage, sandalwood vanilla, and/or ylang-ylang), honey essence, or any combination thereof.

In at least one example embodiment, the oral product may be free of an oil. In at least one example embodiment, the oral product may include an oil. The oil may include, for example, a monoglyceride, a diglyceride, a triglyceride, triacetin, a flavor oil, or any combination thereof. The flavor oil may be or may include a flavorant.

An amount of oil may be selected to achieve a desired texture and/or softness. For example, the softness of the oral product may be increased as an amount of the oil in the oral product increases. In at least one example embodiment, the oral product may include oil in an amount greater than or equal to about 5 weight percent (e.g., greater than or equal to about 8 weight percent, greater than or equal to about 9 weight percent, greater than or equal to about 10 weight percent, greater than or equal to about 11 weight percent, greater than or equal to about 12 weight percent, greater than or equal to about 13 weight percent, or greater than or equal to about 15 weight percent). In at least one example embodiment, the oral product may include oil in an amount less than or equal to about 20 weight percent (e.g., less than or equal to about 15 weight percent, less than or equal to about 14 weight percent, less than or equal to about 13 weight percent, less than or equal to about 12 weight percent, less than or equal to about 11 weight percent, less than or equal to about 10 weight percent, or less than or equal to about 8 weight percent). In at least one example embodiment, the oral product may include the oil in an amount ranging from about 8 weight percent to about 16 weight percent (e.g., ranging from about 10 weight percent to about 14 weight percent, ranging from about 11 weight percent to about 13 weight percent, or about 12 weight percent).

The oral product (e.g., the oral tobacco product, the oral non-tobacco product, or the oral cannabis product) may have various ranges of moisture

In at least one example embodiment, the oral product is a dry oral product having a moisture content greater than or equal to about 5 percent by weight (e.g., greater than or equal to about 6 percent by weight, greater than or equal to about 7 percent by weight, greater than or equal to about 8 percent by weight, or greater than or equal to about 9 percent by weight). In at least one example embodiment, the oral product is a dry oral product having a moisture content less than or equal to about 10 percent by weight (e.g., less than or equal to about 9 percent by weight, less than or equal to about 8 percent by weight, less than or equal to about 7 percent by weight, or less than or equal to about 6 percent by weight). In at least one example embodiment, the oral product is a dry oral product having a moisture content ranging from greater than or equal to about 5 percent by weight to less than or equal to about 10 percent by weight (e.g., greater than or equal to about 6 percent by weight to less than or equal to about 9 percent by weight).

In at least one example embodiment, the oral product has a medium moisture content greater than or equal to about 20 percent by weight (e.g., greater than or equal to about 21 percent by weight, greater than or equal to about 22 percent by weight, greater than or equal to about 23 percent by weight, greater than or equal to about 24 percent by weight, greater than or equal to about 25 percent by weight, greater than or equal to about 26 percent by weight, greater than or equal to about 27 percent by weight, greater than or equal to about 28 percent by weight, greater than or equal to about 29 percent by weight, greater than or equal to about 30 percent by weight, greater than or equal to about 31 percent by weight, greater than or equal to about 32 percent by weight, greater than or equal to about 33 percent by weight, or greater than or equal to about 34 percent by weight). In at least one example embodiment, the oral product has a medium moisture content less than or equal to about 35 percent by weight (e.g., less than or equal to about 34 percent by weight, less than or equal to about 33 percent by weight, less than or equal to about 32 percent by weight, less than or equal to about 31 percent by weight, less than or equal to about 30 percent by weight, less than or equal to about 29 percent by weight, less than or equal to about 28 percent by weight, less than or equal to about 27 percent by weight, less than or equal to about 26 percent by weight, less than or equal to about 25 percent by weight, less than or equal to about 24 percent by weight, less than or equal to about 23 percent by weight, less than or equal to about 22 percent by weight, or less than or equal to about 21 percent by weight). In at least one example embodiment, the oral product has a medium moisture content, such as a moisture content ranging from greater than or equal to about 20 percent by weight to less than or equal to about 35 percent by weight (e.g., greater than or equal to about 21 percent by weight to less than or equal to about 34 percent by weight, greater than or equal to about 22 percent by weight to less than or equal to about 33 percent by weight, greater than or equal to about 23 percent by weight to less than or equal to about 32 percent by weight, greater than or equal to about 24 percent by weight to less than or equal to about 31 percent by weight, greater than or equal to about 23 percent by weight to less than or equal to about 30 percent by weight, or greater than or equal to about 24 percent by weight to less than or equal to about 28 percent by weight).

In at least one example embodiment, the oral product is a wet oral product having a moisture content greater than or equal to about 40 percent by weight (e.g., greater than or equal to about 41 percent by weight, greater than or equal to about 42 percent by weight, greater than or equal to about 43 percent by weight, greater than or equal to about 44 percent by weight, greater than or equal to about 45 percent by weight, greater than or equal to about 46 percent by weight, greater than or equal to about 47 percent by weight, greater than or equal to about 48 percent by weight, greater than or equal to about 49 percent by weight, greater than or equal to about 50 percent by weight, greater than or equal to about 51 percent by weight, greater than or equal to about 52 percent by weight, greater than or equal to about 53 percent by weight, or greater than or equal to about 54 percent by weight). In at least one example embodiment, the oral product is a wet oral product having a moisture content less than or equal to about 55 percent by weight (e.g., less than or equal to about 54 percent by weight, less than or equal to about 53 percent by weight, less than or equal to about 52 percent by weight, less than or equal to about 51 percent by weight, less than or equal to about 50 percent by weight, less than or equal to about 49 percent by weight, less than or equal to about 48 percent by weight, less than or equal to about 47 percent by weight, less than or equal to about 46 percent by weight, less than or equal to about 45 percent by weight, less than or equal to about 44 percent by weight, less than or equal to about 43 percent by weight, less than or equal to about 42 percent by weight, or less than or equal to about 41 percent by weight). In at least one example embodiment, the oral product is a wet oral product having a moisture content ranging from greater than or equal to about 40 percent by weight to less than or equal to about 55 percent by weight (e.g., greater than or equal to about 41 percent by weight to less than or equal to about 54 percent by weight, greater than or equal to about 42 percent by weight to less than or equal to about 53 percent by weight, greater than or equal to about 43 percent by weight to less than or equal to about 52 percent by weight, greater than or equal to about 44 percent by weight to less than or equal to about 51 percent by weight, greater than or equal to about 45 percent by weight to less than or equal to about 50 percent by weight, or greater than or equal to about 46 percent by weight to less than or equal to about 49 percent by weight).

In at least one example embodiment, the oral product may include water. In at least one example embodiment, the oral product may include water in an amount greater than or equal to about 0.5 weight percent (e.g., greater than or equal to about 1 weight percent, greater than or equal to about 5 weight percent, greater than or equal to about 10 weight percent, greater than or equal to about 15 weight percent, greater than or equal to about 20 weight percent, or greater than or equal to about 25 weight percent). In at least one example embodiment, the oral product may include water in an amount less than or equal to about 30 weight percent (e.g., less than or equal to about 25 weight percent, less than or equal to about 20 weight percent, less than or equal to about 15 weight percent, less than or equal to about 10 weight percent, less than or equal to about 5 weight percent, or less than or equal to about 1 weight percent). In at least one example embodiment, the oral product may include water in an amount ranging from about 0.5 weight percent to about 30 weight percent.

In at least one example embodiment, the oral product may be free of water or includes water in an amount less than or equal to about 5 weight percent (e.g., less than or equal to about 4 weight percent, less than or equal to about 3 weight percent, less than or equal to about 2 weight percent, or less than or equal to about 1 weight percent). In at least one example embodiment, the oral product may be free of intentionally added water.

The oral product may be sized and/or shaped and/or configured to be wholly received in an oral cavity of an adult tobacco consumer. The oral product may have an oval shape, a rounded shield shape, a flat shield shape an elliptical shape, an elongated elliptical shape, a semi-circular shape, a square shape, a rounded-edge square shape, a rectangular shape, an elongated rectangular shape, a rounded-edge rectangular shape, a football shape, a boomerang shape, a teardrop shape, a comma shape, a bowtie shape, a peanut shape, a pillow shape, a ravioli shape, an oblong shape, or any combination thereof. The oral product may have an oval-shaped cross section, a rectangular cross section, an elongated rectangular cross section, a lens or football shaped cross section, a boomerang-shaped cross section, a shield-shaped cross section, or any combination thereof. In at least one example embodiment, the size and/or shape and/or configuration of the oral product may be selected to promote desired positioning of the oral product within the oral cavity and/or packaging.

In at least one example embodiment, the oral product may have dimensions ranging from greater than or equal to about 1 millimeter to less than or equal to about 25 millimeters (e.g., greater than or equal to about 1 millimeter to less than or equal to about 10 millimeters, greater than or equal to about 1 millimeter to less than or equal to about 5 millimeters, greater than or equal to about 5 millimeters to less than or equal to about 25 millimeters, greater than or equal to about 5 millimeters to less than or equal to about 10 millimeters, greater than or equal to about 10 millimeters to less than or equal to about 15 millimeters, greater than or equal to about 15 millimeters to less than or equal to about 20 millimeters, or greater than or equal to about 20 millimeters to less than or equal to about 25 millimeters). In at least one example embodiment, the oral product has a first dimension (e.g., smallest dimension or thickness) ranging from greater than or equal to about 1 millimeter to less than or equal to about 10 millimeters (e.g., about 2.5 millimeters). In at least one example embodiment, the oral product has a largest dimension (e.g., diameter, height, or width) ranging from greater than or equal to about 5 millimeters to less than or equal to about 25 millimeters (e.g., about 12 millimeters).

In at least one example embodiment, the oral product may have a weight ranging from greater than or equal to about 1 gram to less than or equal to about 10 grams (e.g., greater than or equal to less than or equal to about 1 gram to about 9 grams, greater than or equal to about 1 gram to less than or equal to about 8 grams, greater than or equal to about 1 gram to less than or equal to about 7 grams, greater than or equal to about 1 gram to less than or equal to about 6 grams, greater than or equal to about 1 gram to less than or equal to about 5 grams, greater than or equal to about 1 gram to less than or equal to about 4 grams, greater than or equal to about 1 gram to less than or equal to about 3 grams greater than or equal to about 1 gram to less than or equal to about 2 grams, greater than or equal to about 2 grams to less than or equal to about 9 grams, greater than or equal to about 2 grams to less than or equal to about 8 grams, greater than or equal to about 2 grams to less than or equal to about 7 grams, greater than or equal to about 2 grams to less than or equal to about 6 grams, greater than or equal to about 2 grams to less than or equal to about 5 grams, greater than or equal to about 2 grams to less than or equal to about 4 grams, greater than or equal to about 2 grams to less than or equal to about 3 grams, greater than or equal to about 3 grams to less than or equal to about 9 grams, greater than or equal to about 3 grams to less than or equal to about 8 grams, greater than or equal to about 3 grams to less than or equal to about 7 grams, greater than or equal to about 3 grams to less than or equal to about 6 grams, greater than or equal to about 3 grams to less than or equal to about 5 grams, greater than or equal to about 3 grams to less than or equal to about 4 grams, greater than or equal to about 4 grams to less than or equal to about 9 grams, greater than or equal to about 4 grams to less than or equal to about 8 grams, greater than or equal to about 4 grams to less than or equal to about 7 grams, greater than or equal to about 4 grams to less than or equal to about 6 grams, greater than or equal to about 4 grams to less than or equal to about 5 grams, greater than or equal to about 5 grams to less than or equal to about 9 grams, greater than or equal to about 5 grams to less than or equal to about 8 grams, greater than or equal to about 5 grams to less than or equal to about 7 grams, greater than or equal to about 5 grams to less than or equal to about 6 grams, greater than or equal to about 6 grams to less than or equal to about 9 grams, greater than or equal to about 6 grams to less than or equal to about 8 grams, greater than or equal to about 6 grams to less than or equal to about 7 grams, greater than or equal to about 7 grams to less than or equal to about 9 grams, greater than or equal to about 7 grams to less than or equal to about 8 grams, or greater than or equal to about 8 grams to less than or equal to about 9 grams).

In at least one example embodiment, the oral product may provide a single serving of a food, drink, oral tobacco product or oral non-tobacco product. A single serving of food can have a weight ranging from about 5 grams to about 450 grams. A single serving of drink ranges from about 200 milliliters to about 600 milliliters. A single serving of an oral pouch product may include one oral product formed as described herein.

In at least one example embodiment, the oral product may include a uniform unitary structure. In at least one example embodiment, the oral product may include two or more continuous or distinct layers. The two or more layers may be separable or inseparable. Each of the two or more layers may have the same or different compositions. For example, in at least one example embodiment, the two or more layers may have different flavors, different amounts of active ingredients (e.g., nicotine or nicotine derivative including no nicotine or nicotine derivative), textures, softnesses, different release relates, or any combination thereof.

In at least one example embodiment, the oral product may include two or more distinct portions or regions and/or one or more distinct patterns. For example, in at least one example embodiment, the oral product may include one or more first layers and one or more second layers disposed around or between or on the one or more first layers.

In at least one example embodiment, the oral product may include one or more binders adhering the one or more first layers and the one or more second layers and/or other layers. In at least one example embodiment, the one or more binders may include film-forming binders. The film-forming binders may include, for example, pectin, gelatin, sodium alginate, maltodextrin, pullulan, xanthan, gum acacia, hydroxy propyl methyl cellulose (HPMC), methyl cellulose, sodium carboxy methyl cellulose, hydroxy propyl cellulose, hydroxyethyl cellulose, polyethylene oxide, polyvinyl alcohol, polyvinyl pyrrolidone, Kollicoat IR, Soluplus® (polyvinyl caprolactam-polyvinyl acetate-polyethylene glycol graft co-polymer), or any combination thereof.

In at least one example embodiment, the oral product may include one or more coatings. The one or more coatings may include any of the described materials. Each of the one or more coatings may include the same or different compositions and structure. For example, in at least one example embodiment, one of the one or more coatings may include a mouth-soluble polymer. In at least one example embodiment, one of the one or more coatings may include a nicotine or a nicotine derivative. In at least one example embodiment, one of the one or more coatings may include a flavorant, a sweetener, or any combination thereof. The weight percentages described herein refer to an uncoated oral product or a body of a coated oral product.

Each of the one or more coatings may partially or fully surround a body of the oral product. In at least one example embodiment, each of the one or more coatings may cover greater than or equal to about 5% of a total surface area of the body (e.g., greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, greater than or equal to about 50%, greater than or equal to about 55%, greater than or equal to about 60%, greater than or equal to about 65%, greater than or equal to about 70%, greater than or equal to about 75%, greater than or equal to about 80%, greater than or equal to about 85%, greater than or equal to about 90%, greater than or equal to about 95%, greater than or equal to about 98%, greater than or equal to about 99%, greater than or equal to about 99.5%).

In at least one example embodiment, each of the one or more coatings may have an average thickness greater than or equal to about 0.1 micrometers (e.g., greater than or equal to about 0.001 millimeters, greater than or equal to about 0.01 millimeters, greater than or equal to about 0.1 millimeters, greater than or equal to about 0.5 millimeters, greater than or equal to about 1 millimeters, greater than or equal to about 1.5 millimeters, or greater than or equal to about 2 millimeters). In at least one example embodiment, each of the one or more coatings may have an average thickness less than or equal to about 2.5 millimeters (e.g., less than or equal to about 2,500 micrometers, less than or equal to about 2,000 micrometers, less than or equal to about 1,500 micrometers, less than or equal to about 1,000 micrometers, less than or equal to about 500 micrometers, less than or equal to about 100 micrometers, less than or equal to about 10 micrometers, or less than or equal to about 1 micrometer). In at least one example embodiment, each of the one or more coatings may have an average thickness greater than or equal to about 0.1 micrometers to less than or equal to about 2.5 millimeters (e.g., greater than or equal to about 0.5 micrometers to less than or equal to about 2 millimeters or greater than or equal to about 1 micrometers to less than or equal to about 1.5 millimeters).

In at least one example embodiment, the oral product may include one or more binders adhering the one or more coatings to the one or more regions or surfaces of the oral product. In at least one example embodiment, the one or more binders may include film-forming binders. The film-forming binders may include, for example, pectin, gelatin, sodium alginate, maltodextrin, pullulan, xanthan, gum acacia, hydroxypropylmethyl cellulose, methyl cellulose, sodium carboxy methyl cellulose, hydroxypropyl cellulose, hydroxyethyl cellulose, polyethylene oxide, polyvinyl alcohol, polyvinyl pyrrolidone, Kollicoat IR, Soluplus® (polyvinyl caprolactam-polyvinyl acetate-polyethylene glycol graft co-polymer), or any combination thereof.

In at least one example embodiment, the oral product may include a functional and/or decorative indicia. The indicia may include, for example, a trademark, a product name, an image, a flavor indicator, a decoration, a date, a product identifier, a manufacturer identifier, a lot number, or any combination thereof. In at least one example embodiment, the indicia are embossed or debossed on an exterior surface of the oral product. In at least one example embodiment, the indicia are in the form of a dissolvable film on the exterior surface of the oral product.

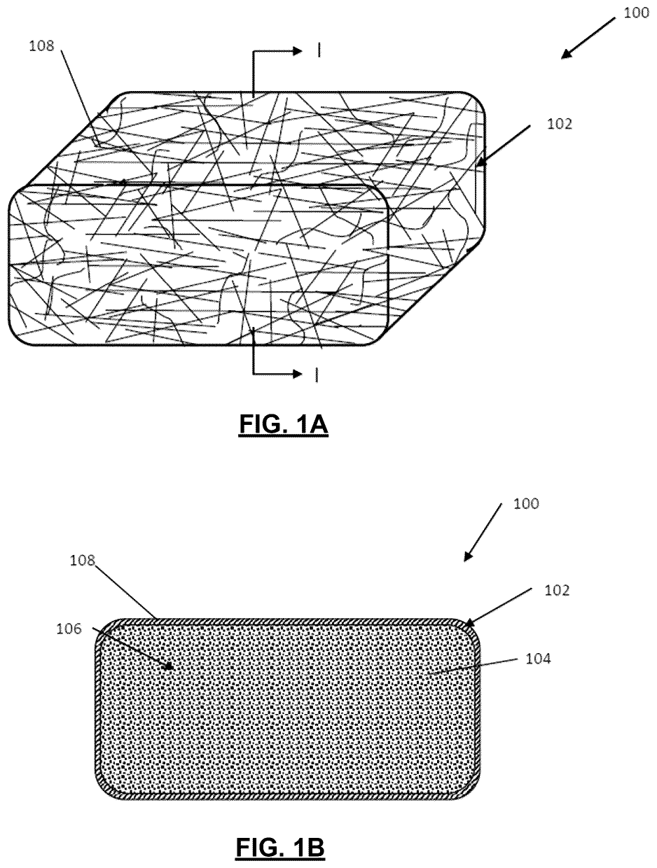

FIG. 1A is a perspective view of an example oral pouch product 100 in accordance with at least one example embodiment. FIG. 1B is a cross-sectional view of the oral pouch product 100 taken along line I-I of FIG. 1A.

The oral pouch product 100 may include a pouch wrapper 102 that at least partially defines a cavity 106 and a filling material 104 disposed in the cavity 106. In at least one example embodiment, the filling material 102 may substantially fill the cavity 106 of the oral pouch product 100. In other example embodiments, the filling material 102 may only partially fill the cavity 106 of the oral pouch product 100. The filling material 102 may include any of the materials and/or compositions detailed above. For example, in at least one example embodiment, the oral pouch product 100 may be an oral tobacco product, an oral non-tobacco product, an oral cannabis product, or any combination thereof and may in various example embodiments include further include one or more elements such as a as a mouth-stable polymer, a mouth-soluble polymer, a sweetener, an energizing agent, a soothing agent, a focusing agent, a plasticizer, a humectant, mouth-soluble or partially-soluble fibers (e.g., sugar beet fibers), an alkaloid, a mineral, a vitamin, a dietary supplement, a nutraceutical, a coloring agent, an amino acid, a chemesthetic agent, an antioxidant, a food-grade emulsifier (e.g., glycerol monostearate, propylene glycol monostearate, an acetylated monoglyceride, polysorbate, or any combination thereof), a pH modifier, a botanical (e.g., green tea), a tooth-whitening agent (e.g., sodium hexametaphosphate (SHMP)), a therapeutic agent, a processing aid, a stearate (e.g., magnesium and/or potassium), a wax, a stabilizer (e.g., ascorbic acid and monosterol citrate, butylated hydroxytoluene (BHT), or butylated hydroxyanisole (BHA)), a lubricant (e.g., sodium lauryl sulfate (SLS)), a disintegrating agent, a preservative (e.g., sodium benzoate), a filler, a flavorant, an effervescent (e.g., carbon dioxide embedded in a flavorant or a filling material), a flavor masking agent, a bitterness receptor site blocker, a receptor site enhancer, other additives, or any combination thereof. The oral pouch product 100 may include multiple additional elements.

The oral pouch product 100 may be an oral pouch product having, for example only, a generally rectangular shape, a ravioli or pillow shape, an oblong shape, or any other suitable shape. Various shapes may be utilized so long as the shapes fit comfortably and discreetly in an adult consumer's mouth. In at least one example embodiment, the oral pouch product 100 is substantially free of oral cavity irritant, which, as used herein, means that the shape, configuration, and position of the oral pouch product 100 do not irritate oral tissues (e.g., gums) via sharp edges and the like. Furthermore, “substantial” and “substantially free” as used in connection with oral cavity irritant means that the shape, configuration, and position of the oral pouch product 100 does not irritate oral tissues (e.g., gums) in a time frame or period having the same order of magnitude as a typical length of time during which the oral pouch product 100 may be enjoyed by an adult consumer. Generally, sharp corners are avoided as sharp corners may lead to oral discomfort.

The oral pouch product 100 may be sized and configured to fit comfortably in an adult consumer's mouth, such as between the cheek and gum. The size of the oral pouch product 100 may be selected based on desired length of placement in an adult consumer's mouth. For example, a larger pouch including a larger amount of filling material may provide for longer placement. In other instances, the oral pouch product 100 may be a mini pouch.

In at least one example embodiment, the oral pouch product 100 may have a major dimension greater than or equal to about 0.20 inch (e.g., greater than or equal to about 0.25 inch, greater than or equal to about 0.75 inch, greater than or equal to about 1 inch, or greater than or equal to about 1.5 inch). In at least one example embodiment, the oral pouch product 100 may have a major dimension less than or equal to about 2.0 inches (e.g., less than or equal to about 1.5 inches, less than or equal to about 1 inches, less than or equal to about 0.75 inches, or less than or equal to about 0.25 inches). In at least one example embodiment, the oral pouch product 100 may have a major dimension greater than or equal to about 0.20 inch to less than or equal to about 2.0 inches (e.g., greater than or equal to about 0.25 inch to less than or equal to about 1.75 inches or greater than or equal to about 0.75 inch to less than or equal to about 1.5 inch).

In at least one example embodiment, the oral pouch product 100 may have a transverse dimension greater than or equal to about 0.25 (e.g., greater than or equal to about 0.5 inch, greater than or equal to about 0.75 inch, or greater than or equal to about 1 inch). In at least one example embodiment, the oral pouch product 100 may have a transverse dimension less than or equal to about 1.5 inches (e.g., less than or equal to about 1 inches, less than or equal to about 0.75 inch, or less than or equal to about 0.5 inch). In at least one example embodiment, the oral pouch product 100 may have a transverse dimension greater than or equal to about 0.25 to less than or equal to about 1.5 inches (e.g., greater than or equal to about 0.50 inch to less than or equal to about 1.25 inches or greater than or equal to about 0.75 inch to less than or equal to about 1.0 inch).

In at least one example embodiment, the oral pouch product 100 may weigh greater than or equal to about 0.25 gram (e.g., greater than or equal to about 0.3 gram, greater than or equal to about 0.4 gram, greater than or equal to about 0.5 gram, or greater than or equal to about 0.75 gram). In at least one example embodiment, the oral pouch product 100 may weigh less than or equal to about 2.0 grams (e.g., less than or equal to about 1.8 grams, less than or equal to about 1.5 grams, less than or equal to about 1.25 grams, or less than or equal to about 1.0 gram). In at least one example embodiment, the oral pouch product 100 may weigh greater than or equal to about 0.25 gram to less than or equal to about 2.0 grams (e.g., greater than or equal to about 0.3 gram to less than or equal to about 1.8 grams, greater than or equal to about 0.4 gram to less than or equal to about 1.5 grams, greater than or equal to about 0.5 gram to less than or equal to about 1.25 grams, or greater than or equal to about 0.75 gram to less than or equal to about 1.0 gram).

In at least one example embodiment, the oral pouch product 100 may be placed in an adult consumer's mouth for greater than or equal about 1 (e.g., greater than or equal to about 1 minute, greater than or equal to about 5 minutes, greater than or equal to about 10 minutes, or greater than or equal to about 20 minutes). In at least one example embodiment, the oral pouch product 100 may be placed in an adult consumer's mouth for less than or equal to about 3 hours (e.g., less than or equal to about 2 hours, less than or equal to about 90 minutes, less than or equal to about 60 minutes, or less than or equal to about 40 minutes). In at least one example embodiment, the oral pouch product 100 may be placed in an adult consumer's mouth for greater than or equal about 1 minute to less than or equal to about 3 hours (e.g., greater than or equal to about 1 minute to less than or equal to about 2 hours, greater than or equal to about 5 minutes to less than or equal to about 90 minutes, greater than or equal to about 10 minutes to less than or equal to about 60 minutes, or greater than or equal to about 20 minutes to less than or equal to about 40 minutes). In at least one example embodiment, the oral pouch product 100 may be discarded after a single placement in an adult consumer's mouth.

In at least one example embodiment, the pouch wrapper 102 may include an outer web 108. The outer web 108 may be formed from a material that is generally recognized as safe (“GRAS”) for use and/or contact with food. The material may be stain resistant, water permeable, porous, or any combination thereof. The outer web 108 can be formed of a permeable material or a semi-permeable material, such that, for example, saliva, water, or both saliva and water can pass through the outer web 108 and into the inner cavity 106 defined by the pouch wrapper 108. Flavors and juices formed by mixing saliva and/or water with the filling material 104 contained within the oral pouch product 100 can be drawn out of the oral pouch product 100 through the outer web 108. The outer web 108 has a desired (or alternatively, predetermined) level for basis weight and/or wet strength to reduce occurrence of breakage of the pouch wrapper 102 during manufacturing operations, storage, and placement in an adult consumer's mouth.

In at least one example embodiment, the outer web 108 may have an average thickness greater than or equal to about 0.05 millimeters (e.g., greater than or equal to about 0.075 millimeters, greater than or equal to about 0.1 millimeters, greater than or equal to about 0.125 millimeters, greater than or equal to about 0.15 millimeters, greater than or equal to about 0.175 millimeters, greater than or equal to about 0.2 millimeters, or greater than or equal to about 0.225 millimeters). In at least one example embodiment, the outer web 108 may have an average thickness less than or equal to about 0.25 millimeters (e.g., less than or equal to about 0.225 millimeters, less than or equal to about 0.2 millimeters, less than or equal to about 0.175 millimeters, less than or equal to about 0.15 millimeters, less than or equal to about 0.125 millimeters, less than or equal to about 0.1 millimeters, or less than or equal to about 0.075 millimeters). In at least one example embodiment, the outer web 108 may have an average thickness greater than or equal to about 0.05 millimeters to less than or equal to about 0.25 millimeters (e.g., greater than or equal to about 0.075 millimeters to less than or equal to about 0.1 millimeters or greater than or equal to about 0.1 millimeters to less than or equal to about 0.2 millimeters).

In at least one example embodiment, the pouch wrapper 102 and/or outer web 108 may include a woven material, a non-woven material, or a combination of the woven material and the non-woven material. In at least one example embodiment, the pouch wrapper 102 and/or outer web 108 may include a polymer. The polymer may include synthetic polymers, natural polymers, or a combination of synthetic polymers and natural polymers. In at least one example embodiment, the pouch wrapper 102 and/or outer web 108 may include a mesh material. The mesh material may be formed of spun or melt-blown fibers, such as polyurethane fibers, as described in U.S. Pat. Nos. 10,448,669, 10,463,070, and 9,414,624, the entire disclosures of each of which are incorporated herein by reference thereto. In at least one example embodiment, the mesh material may be at least partially elastomeric.

In at least one example embodiment, the mesh material may have a basis weight of greater than or equal to about 10 grams per square meter (e.g., greater than or equal to about 15 grams per square meter, greater than or equal to about 20 grams per square meter, greater than or equal to about 25 grams per square meter, greater than or equal to about 30 grams per square meter, greater than or equal to about 35 grams per square meter, greater than or equal to about 40 grams per square meter, or greater than or equal to about 45 grams per square meter). In at least one example embodiment, the mesh material may have a basis weight of less than or equal to about 50 grams per square meter (e.g., less than or equal to about 45 grams per square meter, less than or equal to about 40 grams per square meter, less than or equal to about 35 grams per square meter, less than or equal to about 30 grams per square meter, less than or equal to about 25 grams per square meter, less than or equal to about 20 grams per square meter, or less than or equal to about 15 grams per square meter). In at least one example embodiment, the mesh material may have a basis weight of greater than or equal to about 10 grams per square meter to less than or equal to about 50 grams per square meter (e.g., greater than or equal to about 20 grams per square meter to less than or equal to about 30 grams per square meter).

In at least one example embodiment, the pouch wrapper 102 and/or outer web 108 may include paper. For example, the pouch wrapper 102 and/or outer web 108 may be formed of a cellulose fiber material, such as tea bag material or other materials typically used to form snus pouches. In at least one example embodiment, the pouch wrapper 102 and/or outer web 108 may include a tea bag material having a basis weight of about 16.5 grams per square meter with a wet tensile CD strength of 68 N/m. In at least one example embodiment, the pouch wrapper 102 and/or outer web 108 may be formed of a paper having a wet MD tensile strength of greater than or equal to about 45 N/mm (e.g., greater than or equal to about 46 N/mm, greater than or equal to about 47 N/mm, greater than or equal to about 48 N/mm, greater than or equal to about 49 N/mm, greater than or equal to about 50 N/mm, or greater than or equal to about 51 N/mm). In at least one example embodiment, the pouch wrapper 102 and/or outer web 108 may be formed of a paper having a wet MD tensile strength of less than or equal to about 52 N/mm (e.g., less than or equal to about 51 N/mm, less than or equal to about 50 N/mm, less than or equal to about 49 N/mm, less than or equal to about 48 N/mm, less than or equal to about 47 N/mm, or less than or equal to about 46 N/mm). In at least one example embodiment, the pouch wrapper 102 and/or outer web 108 may be formed of a paper having a wet MD tensile strength of greater than or equal to about 45 N/mm to less than or equal to about 52 N/mm (e.g., greater than or equal to about 46 N/mm to less than or equal to about 51 N/mm, greater than or equal to about 47 N/mm to less than or equal to about 50 N/mm, or greater than or equal to about 48 N/mm to less than or equal to about 49 N/mm).

In at least one example embodiment, the pouch wrapper 102 and/or outer web 108 may include hydrophobic paper or material. The hydrophobic paper may be non-woven material and may include any hydrophobic materials. The hydrophobic materials may be synthetic materials, semi-synthetic materials, or a combination of synthetic materials and semi-synthetic materials. In other example embodiments, the pouch wrapper 102 and/or outer web 108 may be treated such that the pouch wrapper 102 and/or outer web 108 has one or more hydrophobic surfaces. For example, in at least one example embodiment, the hydrophobic paper may be formed from, or coated with, petroleum-based materials. The petroleum-based materials may include polyester, polyethylene, polyurethane, polypropylene, or any combination thereof.

In at least one example embodiment, the pouch wrapper 102 and/or outer web 108 may include a hydrophilic paper or material. For example, the pouch wrapper 102 and/or outer web 108 may include a cellulosic material, viscose, rayon, lyocell, modal fibers, or any combination thereof.

In at least one example embodiment, the pouch wrapper 102 and/or outer web 108 may be free of an added coloring agent. In at least one example embodiment, the pouch wrapper 102 and/or outer web 108 may be white due to a natural color of a polymer used to form the pouch wrapper 102 and/or outer web 108. In other example embodiments, the pouch wrapper 102 and/or outer web 108 may be colored to indicate a flavor of the filling material 104 contained therein. The color of the pouch wrapper 102 and/or outer web 108 may be selected to identify contents thereof. For example, a green pouch wrapper 102 and/or outer web 108 may be used to identify an oral pouch product 100 including a mint flavorant and/or menthol, a red pouch wrapper 102 and/or outer web 108 may be used to identify an oral pouch product 100 including cinnamon, a brown pouch wrapper 102 and/or outer web 108 may be used to identify an oral pouch product 100 including tobacco.

In at least one example embodiment, the pouch wrapper 102 and/or outer web 108 may have a neutral or pleasant taste and/or aroma. In at least one example embodiment, the pouch wrapper 102 and/or outer web 108 may be impregnated and/or coated with at least one flavorant, at least one cannabis material, at least one tobacco material, at least one binder, at least one sensate or chemesthesis agent, at least one functional ingredient, at least one salivation inducing ingredient, or any combination thereof, for example, to enhance a flavor of the filling material 104 contained within the oral pouch product 100. For example, in at least one example embodiment, a substantially continuous coating including the at least one flavorant and/or the at least one cannabis material and/or at least one tobacco material and/or the at least one binder and/or the at least one sensate or chemesthesis agent may be coated on outer (exterior facing) surfaces of the pouch wrapper 102 and/or outer web 108. In at least one example embodiment, the coating may be formed on only a portion of the pouch wrapper 102 and/or outer web 108, such as only along the seams or only on one side of the oral pouch product 100. The coating can provide an initial flavor burst upon placement of the oral pouch product 100 in an oral cavity, while the inner filling material 104 provides a later flavor release to prolong flavor release during placement in an adult consumer's mouth.

In at least one example embodiment, a flavorant (such as those introduced above) may be coated on and/or impregnated in the pouch wrapper 102 and/or outer web 108. In at least one example embodiment, the flavorant may be coated on and/or impregnated in the pouch wrapper 102 and/or outer web 108 in an amount greater than or equal to about 0.01 weight percent based on the weight of the oral pouch product 100 (e.g., greater than or equal to about 0.05 weight percent, greater than or equal to about 1 weight percent, greater than or equal to about 1.5 weight percent, greater than or equal to about 2 weight percent, greater than or equal to about 2.5 weight percent, greater than or equal to about 3 weight percent, greater than or equal to about 3.5 weight percent, greater than or equal to about 4 weight percent, or greater than or equal to about 4.5 weight percent). In at least one example embodiment, the flavorant may be coated on and/or impregnated in the pouch wrapper 102 and/or outer web 108 in an amount ranging less than or equal to about 5 weight percent based on the weight of the oral pouch product 100 (e.g., less than or equal to about 4.5 weight percent, less than or equal to about 4 weight percent, less than or equal to about 3.5 weight percent, less than or equal to about 3 weight percent, less than or equal to about 2.5 weight percent, less than or equal to about 2 weight percent, less than or equal to about 1.5 weight percent, less than or equal to about 1 weight percent, or less than or equal to about 0.5 weight percent). In at least one example embodiment, the flavorant may be coated on and/or impregnated in the pouch wrapper 102 and/or outer web 108 in an amount greater than or equal to about 0.01 weight percent to less than or equal to about 5 weight percent based on the weight of the oral pouch product 100 (e.g., greater than or equal to about 0.01 weight percent to less than or equal to about 4.5 weight percent, greater than or equal to about 1 weight percent to less than or equal to about 4.5 weight percent, greater than or equal to about 1 weight percent to less than or equal to about 4 weight percent, greater than or equal to about 1.5 weight percent to less than or equal to about 3.5 weight percent, or greater than or equal to about 2 weight percent to less than or equal to about 3 weight percent).

In at least one example embodiment, at least one cannabis or tobacco material may be coated on and/or impregnated in the pouch wrapper 102 and/or outer web 108. The at least one cannabis or tobacco material may include, for example only, a ground cannabis or tobacco material, cannabis or tobacco plant fibers, and/or any extract thereof. In at least one example embodiment, the at least one cannabis or tobacco material may be coated on and/or impregnated in the pouch wrapper 102 and/or outer web 108 in an amount greater than or equal to about 0.01 weight percent based on the weight of oral pouch product 100 (e.g., greater than or equal to about 0.05 weight percent, greater than or equal to about 1 weight percent, greater than or equal to about 1.5 weight percent, greater than or equal to about 2 weight percent, greater than or equal to about 2.5 weight percent, greater than or equal to about 3 weight percent, greater than or equal to about 3.5 weight percent, greater than or equal to about 4 weight percent, or greater than or equal to about 4.5 weight percent). In at least one example embodiment, the at least one cannabis or tobacco material may be coated on and/or impregnated in the pouch wrapper 102 and/or outer web 108 in an amount less than or equal to about 5 weight percent based on the weight of oral pouch product 100 (e.g., less than or equal to about 4.5 weight percent, less than or equal to about 4 weight percent, less than or equal to about 3.5 weight percent, less than or equal to about 3 weight percent, less than or equal to about 2.5 weight percent, less than or equal to about 2 weight percent, less than or equal to about 1.5 weight percent, less than or equal to about 1 weight percent, or less than or equal to about 0.5 weight percent). In at least one example embodiment, the at least one cannabis or tobacco material may be coated on and/or impregnated in the pouch wrapper 102 and/or outer web 108 in an amount greater than or equal to about 0.01 weight percent to amount less than or equal to about 5 weight percent based on the weight of oral pouch product 100 (e.g., greater than or equal to about 0.01 weight percent to amount less than or equal to about 4.5 weight percent, greater than or equal to about 1 weight percent to amount less than or equal to about 4 weight percent, greater than or equal to about 1.5 weight percent to amount less than or equal to about 3.5 weight percent, or greater than or equal to about 2 weight percent to amount less than or equal to about 3 weight percent).

In at least one example embodiment, a binder may be coated on and/or impregnated in the pouch wrapper 102 and/or outer web 108. The binder may include a food grade adhesive, gum, or other binder. For example, the binder may include sodium alginate, sugar, agar, guar gum, or any combination thereof. In at least one example embodiment, the binder may be coated on and/or impregnated in the pouch wrapper 102 and/or outer web 108 in an amount greater than or equal to about 0.01 weight percent based on the weight of oral pouch product 100 (e.g., greater than or equal to about 0.05 weight percent, greater than or equal to about 1 weight percent, greater than or equal to about 1.5 weight percent, greater than or equal to about 2 weight percent, greater than or equal to about 2.5 weight percent, greater than or equal to about 3 weight percent, greater than or equal to about 3.5 weight percent, greater than or equal to about 4 weight percent, or greater than or equal to about 4.5 weight percent). In at least one example embodiment, the binder may be coated on and/or impregnated in the pouch wrapper 102 and/or outer web 108 in an amount less than or equal to about 5 weight percent based on the weight of oral pouch product 100 (e.g., less than or equal to about 4.5 weight percent, less than or equal to about 4 weight percent, less than or equal to about 3.5 weight percent, less than or equal to about 3 weight percent, less than or equal to about 2.5 weight percent, less than or equal to about 2 weight percent, less than or equal to about 1.5 weight percent, less than or equal to about 1 weight percent, or less than or equal to about 0.5 weight percent). In at least one example embodiment, the binder may be coated on and/or impregnated in the pouch wrapper 102 and/or outer web 108 in an amount greater than or equal to about 0.01 weight percent to amount less than or equal to about 5 weight percent based on the weight of oral pouch product 100 (e.g., greater than or equal to about 0.01 weight percent to amount less than or equal to about 4.5 weight percent, greater than or equal to about 1 weight percent to amount less than or equal to about 4 weight percent, greater than or equal to about 1.5 weight percent to amount less than or equal to about 3.5 weight percent, or greater than or equal to about 2 weight percent to amount less than or equal to about 3 weight percent).

In at least one example embodiment, the sensate or chemesthesis agent (such as those described below in the discussion of the filling material 102) may be coated on and/or impregnated in the pouch wrapper 102 and/or outer web 108. In at least one example embodiment, the sensate or chemesthesis agent may be coated on and/or impregnated in the pouch wrapper 102 and/or outer web 108 in an amount greater than or equal to about 0.01 weight percent based on the weight of oral pouch product 100 (e.g., greater than or equal to about 0.05 weight percent, greater than or equal to about 1 weight percent, greater than or equal to about 1.5 weight percent, greater than or equal to about 2 weight percent, greater than or equal to about 2.5 weight percent, greater than or equal to about 3 weight percent, greater than or equal to about 3.5 weight percent, greater than or equal to about 4 weight percent, or greater than or equal to about 4.5 weight percent). In at least one example embodiment, the sensate or chemesthesis agent may be coated on and/or impregnated in the pouch wrapper 102 and/or outer web 108 in an amount less than or equal to about 5 weight percent based on the weight of oral pouch product 100 (e.g., less than or equal to about 4.5 weight percent, less than or equal to about 4 weight percent, less than or equal to about 3.5 weight percent, less than or equal to about 3 weight percent, less than or equal to about 2.5 weight percent, less than or equal to about 2 weight percent, less than or equal to about 1.5 weight percent, less than or equal to about 1 weight percent, or less than or equal to about 0.5 weight percent). In at least one example embodiment, the sensate or chemesthesis agent may be coated on and/or impregnated in the pouch wrapper 102 and/or outer web 108 in an amount greater than or equal to about 0.01 weight percent to amount less than or equal to about 5 weight percent based on the weight of oral pouch product 100 (e.g., greater than or equal to about 0.01 weight percent to amount less than or equal to about 4.5 weight percent, greater than or equal to about 1 weight percent to amount less than or equal to about 4 weight percent, greater than or equal to about 1.5 weight percent to amount less than or equal to about 3.5 weight percent, or greater than or equal to about 2 weight percent to amount less than or equal to about 3 weight percent).

In at least one example embodiment, the functional ingredient may be coated on and/or impregnated in the pouch wrapper 102 and/or outer web 108. The functional ingredient may include, for example, an antioxidant, a soothing agent, an energizing agent, an effervescent, or any combination thereof, such as those described below in the discussion of the filling material 102. In at least one example embodiment, the functional ingredient may be coated on and/or impregnated in the pouch wrapper 102 and/or outer web 108 in an amount greater than or equal to about 0.01 weight percent based on the weight of oral pouch product 100 (e.g., greater than or equal to about 0.05 weight percent, greater than or equal to about 1 weight percent, greater than or equal to about 1.5 weight percent, greater than or equal to about 2 weight percent, greater than or equal to about 2.5 weight percent, greater than or equal to about 3 weight percent, greater than or equal to about 3.5 weight percent, greater than or equal to about 4 weight percent, or greater than or equal to about 4.5 weight percent). In at least one example embodiment, the functional ingredient may be coated on and/or impregnated in the pouch wrapper 102 and/or outer web 108 in an amount less than or equal to about 5 weight percent based on the weight of oral pouch product 100 (e.g., less than or equal to about 4.5 weight percent, less than or equal to about 4 weight percent, less than or equal to about 3.5 weight percent, less than or equal to about 3 weight percent, less than or equal to about 2.5 weight percent, less than or equal to about 2 weight percent, less than or equal to about 1.5 weight percent, less than or equal to about 1 weight percent, or less than or equal to about 0.5 weight percent). In at least one example embodiment, the functional ingredient may be coated on and/or impregnated in the pouch wrapper 102 and/or outer web 108 in an amount ranging from greater than or equal to about 0.01 weight percent to amount less than or equal to about 5 weight percent based on the weight of oral pouch product 100 (e.g., greater than or equal to about 0.01 weight percent to amount less than or equal to about 4.5 weight percent, greater than or equal to about 1 weight percent to amount less than or equal to about 4 weight percent, greater than or equal to about 1.5 weight percent to amount less than or equal to about 3.5 weight percent, or greater than or equal to about 2 weight percent to amount less than or equal to about 3 weight percent).

In at least one example embodiment, the filling material 104 may include a dry mixture and a liquid mixture, where at least a portion of the liquid mixture may be absorbed on the dry mixture. In at least one example embodiment, all of the liquid mixture may be absorbed on the dry mixture.

The liquid mixture may include, for example, an oil and an active pharmaceutical ingredient. The oil may include, for example, triglycerides, diglycerides, monoglycerides, triacetin, triolein, trilinolein, vegetable oil, partially-hydrogenated oils, or any combination thereof. The triglyceride may include, for example, long-chain triglycerides, medium chain triglycerides, short chain triglycerides, or any combination thereof. In at least one example embodiment, the filling material 104 may include the oil in an amount greater than or equal to about 0.5 weight percent (e.g., greater than or equal to about 1 weight percent, greater than or equal to about 5 weight percent, greater than or equal to about 10 weight percent, greater than or equal to about 15 weight percent, greater than or equal to about 20 weight percent, greater than or equal to about 25 weight percent, greater than or equal to about 30 weight percent, greater than or equal to about 35 weight percent, greater than or equal to about 40 weight percent, or greater than or equal to about 45 weight percent). In at least one example embodiment, the filling material 104 may include the oil in an amount less than or equal to about 50 weight percent (e.g., less than or equal to about 45 weight percent, less than or equal to about 40 weight percent, less than or equal to about 35 weight percent, less than or equal to about 30 weight percent, less than or equal to about 25 weight percent, less than or equal to about 20 weight percent, less than or equal to about 15 weight percent, less than or equal to about 10 weight percent, less than or equal to about 5 weight percent, or less than or equal to about 1 weight percent). In at least one example embodiment, the filling material 104 may include the oil in an amount greater than or equal to about 0.5 weight percent to less than or equal to about 50 weight percent (e.g., greater than or equal to about 10 weight percent to less than or equal to about 50 weight percent, greater than or equal to about 10 weight percent to less than or equal to about 25 weight percent, or greater than or equal to about 15 weight percent to less than or equal to about 25 weight percent).

In at least one example embodiment, the filling material 104 may be free of water. In at least one example embodiment, the filling material 104 may include water. In at least one example embodiment, no water is intentionally added to the liquid mixture. However, a small amount of water may come into contact with the liquid mixture via other elements in the oral pouch product 100. In at least one example embodiment, the low water content may slow down nicotine degradation and oxidation compared to oral pouch products having higher water content. In at least one example embodiment, the filling material 104 may include water in amount less than or equal to about 5 weight percent (e.g., less than or equal to about 4 weight percent, less than or equal to about 3 weight percent, less than or equal to about 2 weight percent, less than or equal to about 1 weight percent, less than or equal to about 0.5 weight percent, or less than or equal to about 0.25 weight percent).

By including a higher level of oil, the oral pouch product 100 may maintain a relatively moist mouth feel, while maintaining low water content and a water activity level below about 0.7, which can aid in preventing and/or reducing microbial growth and increasing stability of nicotine in the oral pouch product 100. Further, when the wrapper 102 is hydrophobic, since the inner filling material may predominately include oils instead of water, the flavors from the filling material 104 may more readily pass through the pouch wrapper 102 than where a hydrophilic pouch wrapper is used.

In at least one example embodiment, a weight ratio of the dry mixture to the liquid mixture may be greater than or equal to about 60:40 (e.g., greater than or equal to about 65:35, greater than or equal to about 70:30, greater than or equal to about 75:25, greater than or equal to about 80:20, greater than or equal to about 85:15, greater than or equal to about 90:10, or greater than or equal to about 95:5).

The dry mixture may include, for example, an insoluble material or carrier, such as a cellulosic material. In at least one example embodiment, the insoluble material may include, for example, a cellulosic material. In at least one example embodiment, the cellulosic material may include or be derived from sugar beets, wood pulp, cotton, bran, citrus pulp, grass (e.g., switch grass), willow, poplar, or any combination thereof. In at least one example embodiment, the cellulosic material may be a treated cellulosic material, such as microcrystalline cellulose, carboxymethyl cellulose, hydroxypropyl methylcellulose, hydroxypropyl cellulose, or any combination thereof. In at least one example embodiment, the insoluble material may include, for example, water-insoluble fibers. The water-insoluble fibers may include, for example, polypropylene, polyester, polyethylene, polyurethane, or any combination thereof.

In at least one example embodiment, the filling material 104 may include the insoluble material in an amount greater than or equal to about 10 weight percent (e.g., greater than or equal to about 15 weight percent, greater than or equal to about 20 weight percent, greater than or equal to about 25 weight percent, greater than or equal to about 30 weight percent, greater than or equal to about 35 weight percent, greater than or equal to about 40 weight percent, greater than or equal to about 45 weight percent, greater than or equal to about 50 weight percent, greater than or equal to about 55 weight percent, greater than or equal to about 60 weight percent, greater than or equal to about 65 weight percent, greater than or equal to about 70 weight percent, or greater than or equal to about 75 weight percent). In at least one example embodiment, the filling material 104 may include the insoluble material in an amount less than or equal to about 80 weight percent (e.g., less than or equal to about 75 weight percent, less than or equal to about 70 weight percent, less than or equal to about 65 weight percent, less than or equal to about 60 weight percent, less than or equal to about 55 weight percent, less than or equal to about 50 weight percent, less than or equal to about 45 weight percent, less than or equal to about 40 weight percent, less than or equal to about 35 weight percent, less than or equal to about 30 weight percent, less than or equal to about 25 weight percent, less than or equal to about 20 weight percent, or less than or equal to about 15 weight percent). In at least one example embodiment, the filling material 104 may include the insoluble material in an amount greater than or equal to about 10 weight percent to less than or equal to about 80 weight percent (e.g., greater than or equal to about 10 weight percent to less than or equal to about 70 weight percent or greater than or equal to about 30 weight percent to less than or equal to about 60 weight percent).

In at least one example embodiment, the insoluble material may have a particle size of greater than or equal to about 50 micrometers (e.g., greater than or equal to about 100 micrometers, greater than or equal to about 150 micrometers, greater than or equal to about 200 micrometers, greater than or equal to about 250 micrometers, greater than or equal to about 300 micrometers, greater than or equal to about 350 micrometers, greater than or equal to about 400 micrometers, or greater than or equal to about 450 micrometers). In at least one example embodiment, the insoluble material may have a particle size of less than or equal to about 500 micrometers (e.g., less than or equal to about 450 micrometers, less than or equal to about 400 micrometers, less than or equal to about 350 micrometers, less than or equal to about 300 micrometers, less than or equal to about 250 micrometers, less than or equal to about 200 micrometers, less than or equal to about 150 micrometers, or less than or equal to about 100 micrometers). In at least one example embodiment, the insoluble material may have a particle size of greater than or equal to about 50 micrometers to less than or equal to about 500 micrometers (e.g., greater than or equal to about 100 micrometers to less than or equal to about 450 micrometers, greater than or equal to about 150 micrometers to less than or equal to about 400 micrometers, greater than or equal to about 200 micrometers to less than or equal to about 350 micrometers, or greater than or equal to about 250 micrometers to less than or equal to about 300 micrometers).

The dry mixture may include, for example, a water-soluble filler. In at least one example embodiment, the water-soluble filler may include, for example, a sweetener, maltodextrin, psyllium, starch, polysaccharides, a salt, a synthetic polymer, dietary fibers, or any combination thereof. In at least one example embodiment, the filling material 104 may include the water-soluble filler in an amount greater than or equal to about 10 weight percent (e.g., greater than or equal to about 15 weight percent, greater than or equal to about 20 weight percent, greater than or equal to about 25 weight percent, greater than or equal to about 30 weight percent, greater than or equal to about 35 weight percent, greater than or equal to about 40 weight percent, or greater than or equal to about 45 weight percent). In at least one example embodiment, the filling material 104 may include the water-soluble filler in an amount less than or equal to about 50 weight percent (e.g., less than or equal to about 45 weight percent, less than or equal to about 40 weight percent, less than or equal to about 35 weight percent, less than or equal to about 30 weight percent, less than or equal to about 25 weight percent, less than or equal to about 20 weight percent, or less than or equal to about 15 weight percent). In at least one example embodiment, the filling material 104 may include the water-soluble filler in an amount greater than or equal to about 10 weight percent to less than or equal to about 50 weight percent (e.g., greater than or equal to about 15 weight percent to less than or equal to about 45 weight percent, greater than or equal to about 20 weight percent to less than or equal to about 40 weight percent, or greater than or equal to about 25 weight percent to less than or equal to about 35 weight percent).

The materials disposed in the cavity 106 and defining the filling material 104 may be provided in the form of a plurality of capsules, microcapsules, beads of various sizes, or any combination thereof. The capsules, microcapsules, and/or beads may have a size that is determined by the desired size of the final product (e.g., oral pouch product 100). For example, in at least one example embodiment, the capsules, microcapsules, and/or beads may range in size from greater than or equal to about 0.1 millimeters to less than or equal to about 8 millimeters depending on the ingredients contained therein.

In at least one example embodiment, the capsules, microcapsules, and/or beads may include an outer shell and an inner core, where varying the thickness of the outer shells of the capsules, microcapsules, and/or beads may allow for ingredients contained in the capsules, microcapsules, and/or beads to be released at varying rates to prolong the flavor and/or functional experience of the oral pouch product 100. In at least one example embodiment, the shells may have averages thicknesses ranging from greater than or equal to about 0.1 millimeters to less than or equal to about 7 millimeters, depending on the size of the capsules, microcapsules, and/or beads and a desired dissolution rate. The capsules, microcapsules, and/or beads having the thinnest shells may dissolve first to release the enclosed flavors and functional ingredients, while capsules, microcapsules, and/or beads having thicker shells may dissolve at a slower rate to provide continued flavor and functional ingredients.

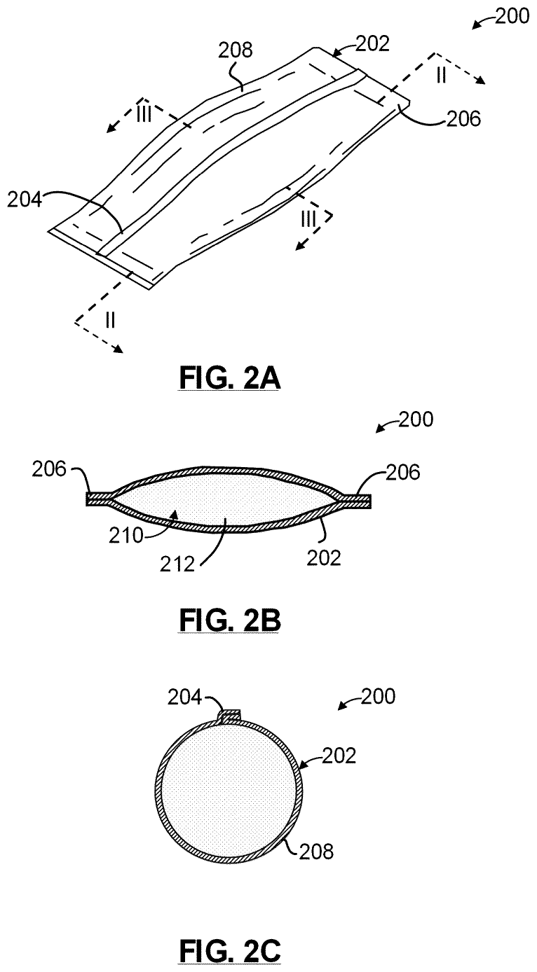

FIG. 2A is a perspective view of another example oral pouch product 200 in accordance with at least one example embodiment. FIG. 2B is a cross-sectional view of the oral pouch product 200 along line II-II of FIG. 2A. FIG. 2C is a cross-sectional view of the oral pouch product 200 along line III-III of FIG. 2A.

The oral pouch product 200 illustrated in FIGS. 2A-2C having a pouch wrapper 202 and that at least partially defines a cavity 210 and a filling material 212 disposed in the cavity 210 is the same as the oral pouch product 100 illustrated in FIGS. 1A and 1B except that the pouch wrapper 202 may include one or more seals or seams, including longitudinal seal 204 and fin seals 206.

Each fin seal 206 may be formed by bringing together an inner surface of the outer web 208 of the pouch wrapper 202 and another section of the inner surface of the outer web 208 in a superposed relation to form one of the fin seal. The longitudinal seal 204 may extend between the fin seals 206. In at least one example embodiment, the longitudinal seal 204 may include overlapping edge portions of an outer web 208 that are sealed together. In at least one example embodiment, the seals 204, 206 may have a dimension of less than or equal to about 1 millimeter. The sealing function can be accomplished by a food grade adhesive or by mutually sealing the overlapping edge portions, using thermal or sonic techniques.

In at least one example embodiment, opposing layers of an outer web 208, the longitudinal seal 204, and the fin seals 206 may define the cavity 210 therebetween. In at least one example embodiment, the filling material 212 may substantially fill the cavity 210 of the oral pouch product 200. In other example embodiments, the filling material 210 may only partially fill the cavity 210 of the oral pouch product 200.

Although not illustrated, it should be appreciated that, in various other example embodiments, integrated fin and longitudinal seals may be used, as would be recognized by the skilled artisan. By overlapping a fin seal, the oral pouch product 200 may be made more comfortable for insertion in the adult consumer's mouth because there are no loose, unsealed edges that may stick out and snag the consumer's mouth during enjoyment. In addition, integrated fin and longitudinal seals may be stronger to reduce and/or prevent breakage during manufacture, packaging, shipment, placement, and/or use of the oral pouch product 200.

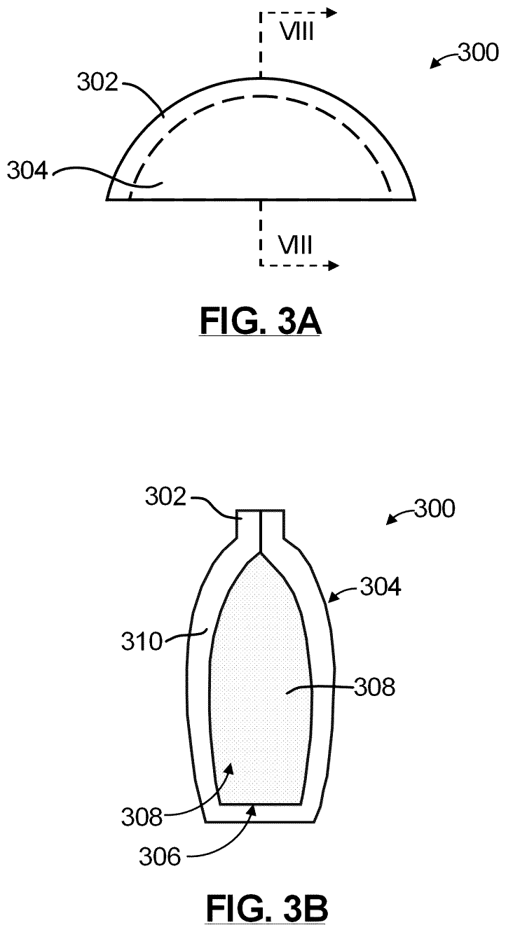

FIG. 3A is a side view of another example oral pouch product 300 in accordance with at least one example embodiment. FIG. 3B is a cross-sectional view along line VIII-VIII of the oral pouch product 300 of FIG. 3A.

The oral pouch product 300 illustrated in FIGS. 3A and 3B having a pouch wrapper 304 that at least partially defines a cavity 306 and a filling material 308 disposed in the cavity 306 is the same as the oral pouch product 100 illustrated in FIGS. 1A and 1B except that the oral pouch product 300 has a single seam or seal 302 along a pouch wrapper 304.

The pouch wrapper 304 can be sealed along the seam or seal 302 to define an inner cavity 306 that may be configured to contain or hold the filling material 308. The single seam or seal 302 can be formed by bringing together an inner surface of an outer web 310 of the pouch wrapper 304 and another section of the inner surface of the outer web 310 in a superposed relation. The sealing function can be accomplished by a food grade adhesive or by mutual sealing the adjacent portions, using thermal or sonic techniques. In at least one example embodiment, as illustrated, the oral pouch product 300 may have a half-moon shape. Although not illustrated, it should be appreciated that, in various other example embodiments, the pouch oral pouch product 300 may have a D-shape, boomerang, crescent, or other shape.

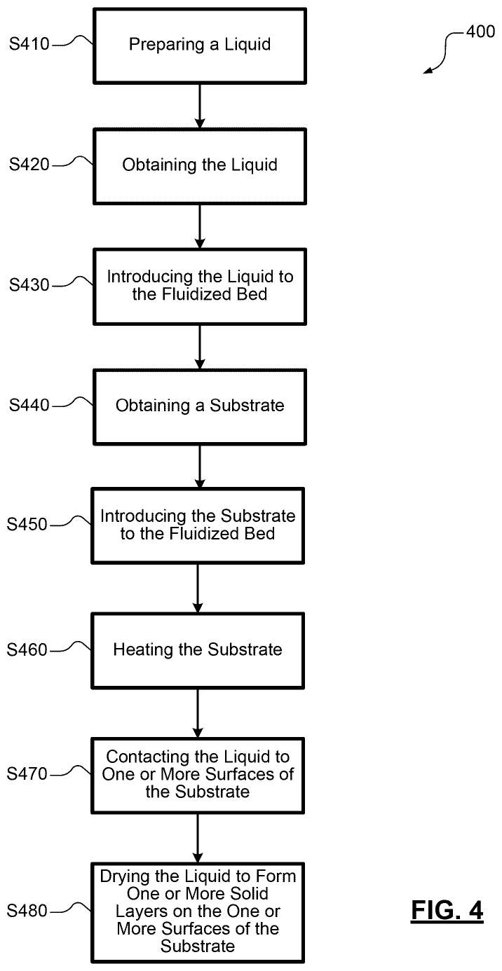

The present disclosure provides methods for forming oral products. For example, FIG. 4 is a flowchart illustrating an example method 400 for preparing an oral product (including, for example, the oral pouch product 100 illustrated in FIGS. 1A and 1B and/or the oral pouch product 200 illustrated in FIGS. 2A-2C and/or the oral pouch product 300 illustrated in FIGS. 3A and 3B) in accordance with at least one example embodiment.

The method 400 may include contacting S470 a liquid with one or more surfaces of a substrate. The method 400 may further include drying S480 the liquid as contacted with the one or more surfaces of the substrate to form one or more flexible, solid layers. During the contacting S470 and the drying S480, atomized droplets may uniformly bind on the one or more surfaces of the substrate by way of a binder that converts into a solid when dried. The one or more flexible, solid layers also be referred to as dry layers. The one or more flexible, solid layers are layers having a moisture content less than or equal to about 10 weight percent. Although the contacting S470 and the drying S480 are illustrated in FIG. 4 as separate steps, it should be appreciated that, in various example embodiments, the drying S480 may occur at least in part concurrently with the contacting S470, such that the liquid is contacted with the one or more surfaces of the substrate to form one or more solid layers that define at least a portion of the oral product. Although a single contacting S470 is illustrated, it should be appreciated that, in various example embodiments, the method 400 may include two or more contacting S470 and/or drying S480 steps. The liquid may be the same or different in subsequential contacting S470 steps.

In at least one example embodiment, the method 400 may further include obtaining S420 the liquid. In at least one example embodiment, the method 400 may further include preparing S410 the liquid. The preparing S410 of the liquid may include contacting the binder, the flavorant, the plasticizer, or any combination thereof to the carrier. Although the obtaining S420 of the liquid and the preparation S410 of the liquid are illustrated in FIG. 4 as separate steps, it should be appreciated that, in various example embodiments, the obtaining S420 of the liquid may occur at least in part concurrently with the preparation S410 of the liquid.

In at least one example embodiment, the liquid may include a binder and a carrier. The binder and carrier may include those detailed above. The binder that is selected forms a solid when dried. In at least one example embodiment, the liquid may include the binder in an amount greater than or equal to about 0.1 weight percent (e.g., greater than or equal to about 5 weight percent, greater than or equal to about 10 weight percent, greater than or equal to about 15 weight percent, greater than or equal to about 20 weight percent, greater than or equal to about 25 weight percent, or greater than or equal to about 30 weight percent). In at least one example embodiment, the liquid may include the binder in an amount less than or equal to about 35 weight percent (e.g., less than or equal to about 30 weight percent, less than or equal to about 25 weight percent, less than or equal to about 20 weight percent, less than or equal to about 15 weight percent, less than or equal to about 10 weight percent, or less than or equal to about 5 weight percent). In at least one example embodiment, the liquid may include the binder in an amount greater than or equal to about 0.1 weight percent to less than or equal to about 35 weight percent.

In at least one example embodiment, the liquid may include a flavorant. The flavorant may include those detailed above. In at least one example embodiment, the liquid may include the flavorant in an amount greater than or equal to about 0.1 weight percent (e.g., greater than or equal to about 5 weight percent, greater than or equal to about 10 weight percent, greater than or equal to about 15 weight percent, greater than or equal to about 20 weight percent, greater than or equal to about 25 weight percent, greater than or equal to about 30 weight percent, greater than or equal to about 35 weight percent, greater than or equal to about 40 weight percent, greater than or equal to about 45 weight percent). In at least one example embodiment, the liquid may include the flavorant in an amount less than or equal to about 50 weight percent (e.g., less than or equal to about 45 weight percent, less than or equal to about 40 weight percent, less than or equal to about 35 weight percent, less than or equal to about 30 weight percent, less than or equal to about 25 weight percent, less than or equal to about 20 weight percent, less than or equal to about 15 weight percent, less than or equal to about 10 weight percent, or less than or equal to about 5 weight percent).

In at least one example embodiment, the liquid may include a plasticizer. The plasticizer may include those detailed above. In at least one example embodiment, the liquid may the plasticizer in an amount greater than or equal to about 0.1 weight percent (e.g., greater than or equal to about 2 weight percent, greater than or equal to about 4 weight percent, greater than or equal to about 6 weight percent, greater than or equal to about 8 weight percent, greater than or equal to about 10 weight percent, greater than or equal to about 12 weight percent, or greater than or equal to about 14 weight percent). In at least one example embodiment, the liquid may the plasticizer in an amount less than or equal to about 15 weight percent (e.g., less than or equal to about 14 weight percent, less than or equal to about 12 weight percent, less than or equal to about 10 weight percent, less than or equal to about 8 weight percent, less than or equal to about 6 weight percent, less than or equal to about 4 weight percent, or less than or equal to about 2 weight percent). In at least one example embodiment, the liquid may the plasticizer in an amount greater than or equal to about 0.1 weight percent to less than or equal to about 15 weight percent.

The liquid may be provided as a solution, a suspension, or an emulsion. The liquid may be selected to further stabilize active components supported within or by an oral product prepared using the substrate including the one or more flexible, solid layers. In at least one example embodiment, the liquid may include, in water, hydroxy propyl methyl cellulose as a binder, polyethylene glycol as a plasticizer, and peppermint as a flavorant.

In at least one example embodiment, the method 400 may further include obtaining S440 the substrate. Although the obtaining S440 of the substrate is illustrated as occurring after the obtaining S420 of the liquid, it should be appreciated that, in various example embodiments, the obtaining S440 of the substrate may occur before or after the obtaining S420 of the liquid.

In at least one example embodiment, the substrate may be fully dissolvable in an aqueous solution. In at least one example embodiment, the substrate may not be fully dissolvable in an aqueous solution. In at least one example embodiment, the substrate may include paper, a web material, or a combination of the paper and the web material. The paper may include, for example, natural materials. The natural materials may include, for example, rayon, silk, cotton, polyester, cellulosic material, or any combination thereof. In at least one example embodiment, the cellulosic material may include hydroxypropyl cellulose. In at least one example embodiment, the cellulosic material may include reconstituted cellulosic materials. The web material may include, for example, synthetic polymers. The synthetic polymers may include, for example, polypropylene, low density polyethylene, polyethylene terephthalate, polyurethane, polyvinyl acetate, polyvinyl alcohol, styrene, ethyl vinyl acetate, or any combination thereof.

In at least one example embodiment, the contacting S470 and the drying S480 may occur using a fluidized bed reactor. For example, in at least one example embodiment, the method 400 may include introducing S430 the liquid to the fluidized bed and introducing S450 the substrate to the fluidized bed. Although the introduction S450 of the substrate to the fluidized bed is illustrated in FIG. 4 as occurring after the introduction S430 of the liquid, it should be appreciated that, in various example embodiments, the introduction S450 of the substrate may occur before the introduction S430 of the liquid or at least in part concurrently with the introduction S430 of the liquid.

Air flow in the fluidized bed reactor during the contacting S470 may be greater than or equal to about 250 rpm (e.g., greater than or equal to about 255 rpm, greater than or equal to about 260 rpm, greater than or equal to about 265 rpm, greater than or equal to about 270 rpm, greater than or equal to about 275 rpm, greater than or equal to about 280 rpm, or greater than or equal to about 285 rpm). The air flow in the fluidized bed reactor during the contacting S470 and the drying S480 may be less than or equal to about 290 rpm (e.g., less than or equal to about 285 rpm, less than or equal to about 280 rpm, less than or equal to about 275 rpm, less than or equal to about 270 rpm, less than or equal to about 265 rpm, less than or equal to about 260 rpm, or less than or equal to about 255 rpm). The air flow in the fluidized bed reactor during the contacting S470 and the drying S480 may be greater than or equal to about 250 rpm to less than or equal to about 290 rpm.

The fluidized bed reactor may have a first inlet air temperature during the contacting S470. In at least one example embodiment, the first inlet air temperature may be greater than or equal to about 50 °C (e.g., be greater than or equal to about 52 °C, greater than or equal to about 54 °C, greater than or equal to about 56 °C, greater than or equal to about 58 °C, greater than or equal to about 60 °C, greater than or equal to about 62 °C, greater than or equal to about 64 °C, greater than or equal to about 66 °C, or greater than or equal to about 68 °C). In at least one example embodiment, the first inlet air temperature for the fluidized bed reactor during the contacting S470 and the drying S480 may be less than or equal to about 70 °C (e.g., less than or equal to about 68 °C, less than or equal to about 66 °C, less than or equal to about 64 °C, less than or equal to about 62 °C, less than or equal to about 60 °C, less than or equal to about 58 °C, less than or equal to about 56 °C, less than or equal to about 54 °C, or less than or equal to about 52 °C). In at least one example embodiment, the first inlet air temperature may be greater than or equal to about 50 °C to less than or equal to about 70 °C.

Using the fluidized bed, the contacting S470 may include spraying the liquid onto the one or more surfaces of the substrate. In at least one example embodiment, a spray rate during the contacting S470 may be greater than or equal to about 0.1 g/min (e.g., greater than or equal to about 0.5 g/min, greater than or equal to about 1 g/min, greater than or equal to about 1.5 g/min, greater than or equal to about 2 g/min, or greater than or equal to about 2.5 g/min). In at least one example embodiment, the spray rate during the contacting S470 may be less than or equal to about 3 g/min (e.g., less than or equal to about 2.5 g/min, less than or equal to about 2 g/min, less than or equal to about 1.5 g/min, less than or equal to about 1 g/min, or less than or equal to about 0.5 g/min). In at least one example embodiment, the spray rate during the contacting S470 may be greater than or equal to about 0.1 g/min to less than or equal to about 3 g/min.

An atomization air pressure during the contacting S470 may be variable. In at least one example embodiment, the atomization air pressure during the contacting S470 may be greater than or equal to about 68.9 kPa (e.g., greater than or equal to about 70 kPa, greater than or equal to about 80 kPa, greater than or equal to about 90 kPa, greater than or equal to about 100 kPa, greater than or equal to about 110 kPa, greater than or equal to about 120 kPa, greater than or equal to about 130 kPa, greater than or equal to about 140 kPa, greater than or equal to about 150 kPa, greater than or equal to about 160 kPa, or greater than or equal to about 170 kPa). In at least one example embodiment, the atomization air pressure during the contacting S470 may be less than or equal to about 172.3 kPa (e.g., less than or equal to about 170 kPa, less than or equal to about 160 kPa, less than or equal to about 150 kPa, less than or equal to about 140 kPa, less than or equal to about 130 kPa, less than or equal to about 120 kPa, less than or equal to about 110 kPa, less than or equal to about 100 kPa, less than or equal to about 90 kPa, less than or equal to about 80 kPa, or less than or equal to about 70 kPa). In at least one example embodiment, the atomization air pressure during the contacting S470 may be greater than or equal to about 68.9 kPa to less than or equal to about 172.3 kPa.

The contacting S470 may continue for a first time period. In at least one example embodiment, the first time period may be greater than or equal to about 5 minutes (e.g., greater than or equal to about 6 minutes, greater than or equal to about 7 minutes, greater than or equal to about 8 minutes, greater than or equal to about 9 minutes, greater than or equal to about 10 minutes, greater than or equal to about 11 minutes, greater than or equal to about 12 minutes, greater than or equal to about 13 minutes, or greater than or equal to about 14 minutes). In at least one example embodiment, the first time period may be less than or equal to about 15 minutes (e.g., less than or equal to about 14 minutes, less than or equal to about 13 minutes, less than or equal to about 12 minutes, less than or equal to about 11 minutes, less than or equal to about 10 minutes, less than or equal to about 9 minutes, less than or equal to about 8 minutes, less than or equal to about 7 minutes, or less than or equal to about 6 minutes). In at least one example embodiment, the first time period may be greater than or equal to about 5 minutes to less than or equal to about 15 minutes (e.g., about 10 minutes).

In at least one example embodiment, the drying S480 may continue for a second time period beyond the first time period. In at least one example embodiment, the second time period may be greater than or equal to about 2 minutes (e.g., greater than or equal to about 3 minutes, greater than or equal to about 4 minutes, greater than or equal to about 5 minutes, greater than or equal to about 6 minutes, greater than or equal to about 7 minutes, greater than or equal to about 8 minutes, greater than or equal to about 9 minutes, greater than or equal to about 10 minutes, greater than or equal to about 11 minutes, greater than or equal to about 12 minutes, greater than or equal to about 13 minutes, or greater than or equal to about 14 minutes). In at least one example embodiment, the second time period may be less than or equal to about 15 minutes (e.g., less than or equal to about 14 minutes, less than or equal to about 13 minutes, less than or equal to about 12 minutes, less than or equal to about 11 minutes, less than or equal to about 10 minutes, less than or equal to about 9 minutes, less than or equal to about 8 minutes, less than or equal to about 7 minutes, less than or equal to about 6 minutes, less than or equal to about 5 minutes, less than or equal to about 4 minutes, or less than or equal to about 3 minutes). In at least one example embodiment, the second time period may be greater than or equal to about 2 minutes to less than or equal to about 15 minutes (e.g., 4 minutes).

During the second time period, the fluidized bed reactor may have a second inlet air temperature. In at least one example embodiment, the second inlet air temperature may be greater than or equal to about 35 °C (e.g., greater than or equal to about 37 °C, greater than or equal to about 39 °C, greater than or equal to about 41 °C, greater than or equal to about 43 °C, greater than or equal to about 45 °C, greater than or equal to about 47 °C, greater than or equal to about 49 °C, greater than or equal to about 51 °C, greater than or equal to about 53 °C, greater than or equal to about 55 °C, greater than or equal to about 57 °C, greater than or equal to about 59 °C, greater than or equal to about 61 °C, greater than or equal to about 63 °C, greater than or equal to about 65 °C, greater than or equal to about 67 °C, or greater than or equal to about 69 °C). In at least one example embodiment, the second inlet air temperature may be less than or equal to about 70 °C (e.g., less than or equal to about 68 °C, less than or equal to about 66 °C, less than or equal to about 64 °C, less than or equal to about 62 °C, less than or equal to about 60 °C, less than or equal to about 58 °C, less than or equal to about 56 °C, less than or equal to about 54 °C, or less than or equal to about 52 °C). In at least one example embodiment, the second inlet air temperature may be greater than or equal to about 35 °C to less than or equal to about 70 °C. In at least one example embodiment, the second inlet air temperature may be the same as the first inlet air temperature for at least a portion of the second time period. Although not illustrated, it should be appreciated that, in various example embodiment, the method 400 may include decreasing the inlet air temperature from the first inlet air temperature to the second inlet air temperature. The inlet air temperature may be decreased before or concurrent with the drying S480.

In at least one example embodiment, the method 400 may include heating S460 the substrate to a first temperature. In at least one example embodiment, the first temperature may be greater than or equal to about 40 °C (e.g., greater than or equal to about 41 °C, greater than or equal to about 42 °C, greater than or equal to about 43 °C, greater than or equal to about 44 °C, greater than or equal to about 45 °C, greater than or equal to about 46 °C, greater than or equal to about 47 °C, greater than or equal to about 48 °C, or greater than or equal to about 49 °C). In at least one example embodiment, the first temperature may be less than or equal to about 50 °C (e.g., be less than or equal to about 49 °C, be less than or equal to about 48 °C, be less than or equal to about 47 °C, be less than or equal to about 46 °C, be less than or equal to about 45 °C, be less than or equal to about 44 °C, be less than or equal to about 43 °C, be less than or equal to about 42 °C, or be less than or equal to about 41 °C). In at least one example embodiment, the first temperature may be greater than or equal to about 40 °C to less than or equal to about 50 °C. Although the heating S460 of the substrate is illustrated as occurring after the introduction S430 of the liquid into the fluidized bed and also the introduction S450 of the substrate into the fluidized bed, it should be appreciated that, in various example embodiments, the heating S540 of the substrate may occur after the introduction S450 of the substrate into the fluidized bed and before the introduction S430 of the liquid.

Although not illustrated, it should be appreciated that, in various example embodiments, the method 400 may further include preparing the substrate prior to the introduction S450 of the substrate into the fluidized bed. The preparation of the substrate may include cutting the substrate to a desired shape and size for the oral product.

Although not illustrated, it should be appreciated that, in various example embodiments, the method 400 may further include cutting the substrate including the one or more flexible, solid layers to a desired shape and size for the oral product.

Although not illustrated, it should be appreciated that, in various example embodiment, the method 400 may further include defining one or more cavities using the substrate and/or filling the one or more cavities as define by the substrate.

Although not illustrated, it should be appreciated that, in various example embodiments, the method 400 may further include folding and sealing the substrate including the one or more flexible, solid layers to form a desired shape and size for the oral product.

Although not illustrated, it should be appreciated that, in various example embodiments, the method 400 may further include aligning two or more substrates including the one or more flexible, solid layers and sealing one or more of the edges of the two or more substrates to form a desired shape and size for the oral product.

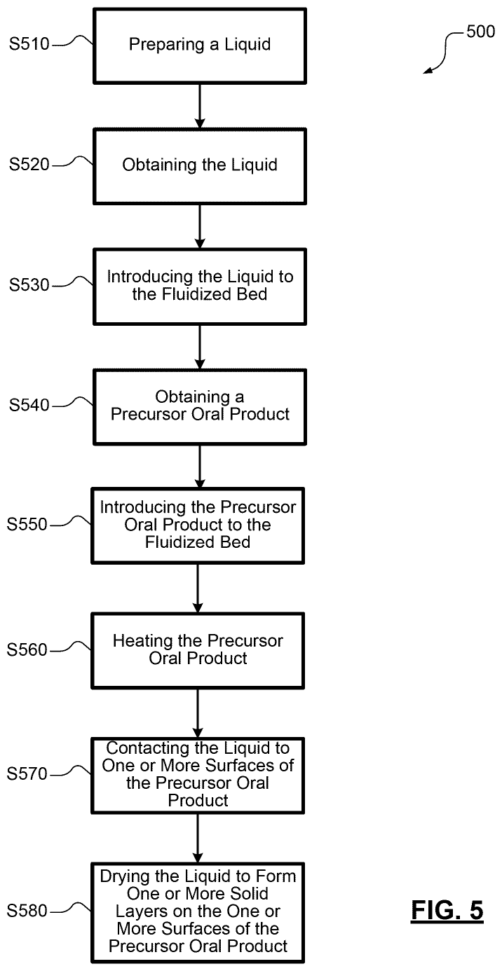

FIG. 5 is a flowchart illustrating another example method 500 for preparing an oral product (including, for example, the oral pouch product 100 illustrated in FIGS. 1A and 1B and/or the oral pouch product 200 illustrated in FIGS. 2A-2C and/or the oral pouch product 300 illustrated in FIGS. 3A and 3B) in accordance with at least one example embodiment.

The method 500 illustrated in FIG. 5 may be the same as the method 400 illustrated in FIG. 4 except that the liquid is contacted to a precursor oral product, such as a filled oral pouch, instead of a substrate. The method 500 includes contacting S570 the liquid to one or more surfaces of the precursor oral product and drying S580 the liquid to form one or more of the oral product. The method 500 may also include, additionally, or alternatively, preparing the liquid S510, obtaining the liquid S520, introducing S530 the liquid to the fluidized bed, obtaining S540 a precursor oral product, introducing S550 the precursor oral product to the fluidized bed, and heating S560 the precursor oral product.

In at least one example embodiment, a total surface area of the one or more surfaces of the precursor oral product contacted S570 by the liquid may be greater than or equal to about 250 mm² (e.g., greater than or equal to about 300 mm², greater than or equal to about 350 mm², greater than or equal to about 400 mm², or greater than or equal to about 450 mm²). In at least one example embodiment, a total surface area of the one or more surfaces of the precursor oral product contacted S570 by the liquid may be less than or equal to about 500 mm² (e.g., less than or equal to about 450 mm², less than or equal to about 400 mm², less than or equal to about 350 mm², or less than or equal to about 300 mm²).

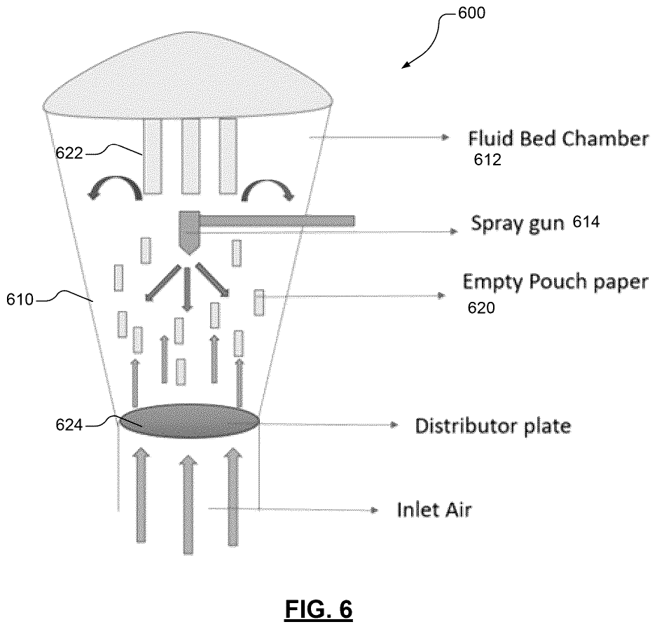

FIG. 6 is a schematic illustrating an example fluidized bed reactor 800 for use in the preparation of an oral product (including, for example, the oral pouch product 100 illustrated in FIGS. 1A and 1B and/or the oral pouch product 200 illustrated in FIGS. 2A-2C and/or the oral pouch product 300 illustrated in FIGS. 3A and 3B) such as in accordance with method 400 as illustrated in FIG. 4 and/or the method 500 illustrated in FIG. 5. The fluidized bed reactor 600 includes a housing 610 that defines a fluid bed chamber 612 that is configured to receive the substrate 620. A spray mechanism 614 extends into the fluid bed chamber 612 such that the liquid may be sprayed onto the one or more surfaces of the substrate 620 (or precursor oral product as in the instance of method 500 as illustrated in FIG. 5). The spray mechanism 614 may be supported by the housing 610. In at least one example embodiment, the fluidized bed reactor 600 may include a one or more filters 622 that help to trap loose fluidized materials and/or to re-direct the loose fluidized materials to a contact zone of the fluid bed chamber 612 below the spray mechanism 614. In at least one example embodiment, the fluidized bed reactor 600 may include a distribution plate 624 that helps to prevent materials from flowing out of the fluid bed chamber 612.

The fluidized bed reactor 600 may also include one or more controllers configured to execute one or more programs or acts for one or more of the one or more other parts or components or portions of the fluidized bed reactor (e.g., the spray mechanism 614 and/or the fluid bed chamber 612). In at least one example embodiment, the controller may include processing circuitry such as hardware including logic circuits, a hardware/software combination such as a processor executing software, or a combination thereof. The processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The controller may include two or more controllers configured independently or together to execute one or more programs or acts using the one or more other part or component or portion.

While some example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

Although described with reference to specific examples and drawings, modifications, additions and substitutions of example embodiments may be variously made according to the description by those of ordinary skill in the art. For example, the described techniques may be performed in an order different with that of the methods described, and/or elements such as the described system, architecture, devices, circuit, and the like, may be connected or combined to be different from the above-described methods, or results may be appropriately achieved by other elements or equivalents.

Illustrative Embodiment 1. A method for forming an oral product, the method comprising: contacting a liquid to one or more surfaces of a substrate in a fluidized bed reactor, the liquid including a binder and a flavorant; and drying the liquid in the fluidized bed reactor to form one or more flexible, solid layers, the one or more flexible, solid layers having a moisture content of less than or equal to about 10 weight percent.

Illustrative Embodiment 2. The method of illustrative embodiment 1, wherein at least a portion of the drying occurs concurrent with the contacting.

Illustrative Embodiment 3. The method of any of illustrative embodiments 1-2, wherein the liquid includes greater than or equal to about 0.1 weight % to less than or equal to about 35 weight % of the binder.

Illustrative Embodiment 4. The method of any of illustrative embodiments 1-3, wherein the binder includes pectin, gelatin, sodium alginate, maltodextrin, pullulan, xanthan, gum acacia, hydroxypropylmethyl cellulose, methyl cellulose, sodium carboxy methyl cellulose, hydroxypropyl cellulose, hydroxyethyl cellulose, polyethylene oxide, polyvinyl alcohol, polyvinyl pyrrolidone, polyvinyl caprolactam-polyvinyl acetate-polyethylene glycol graft co-polymer, or any combination thereof.

Illustrative Embodiment 5. The method of any of illustrative embodiments 1-4, wherein the binder includes hydroxy propyl methyl cellulose.

Illustrative Embodiment 6. The method of any of illustrative embodiments 1-5, wherein the liquid includes greater than or equal to about 0.1 weight % to less than or equal to about 50 weight % of the flavorant.

Illustrative Embodiment 7. The method of any of illustrative embodiments 1-6, wherein the flavorant includes a fruit flavorant, a liquor or liqueur flavorant, a mint flavorant, a floral flavorant, a spice, an herb, or any combination thereof.

Illustrative Embodiment 8. The method of any of illustrative embodiments 1-7, wherein the flavorant includes bergamot, berry, cherry, lemon, orange, bourbon, cognac, scotch, whiskey, Japanese mint, menthol, peppermint, spearmint, wintergreen, mint oils from a species of genus Mentha, geranium, lavender, rose, anise, apium graveolens, caraway, cardamom, cascarilla, cassia, cinnamon, chamomile, clove, cocoa, coffee, coriander, fennel, ginger, jasmine, licorice, nutmeg, pimenta, sage, sandalwood vanilla, ylang-ylang, honey essence, or any combination thereof.

Illustrative Embodiment 9. The method of any of illustrative embodiments 1-8, wherein the flavorant includes peppermint.

Illustrative Embodiment 10. The method of any of illustrative embodiments 1-9, wherein the liquid further includes a plasticizer.

Illustrative Embodiment 11. The method of illustrative embodiment 10, wherein the liquid includes greater than or equal to about 0.1 weight % to less than or equal to about 15 weight % of the plasticizer.

Illustrative Embodiment 12. The method of illustrative embodiment 10, wherein the plasticizer includes polyethylene glycol, a triglyceride, triacetin, propylene glycol, glycerin, vegetable oil, a phthalate, an ester of a polycarboxylic acid with a linear or branched aliphatic alcohol of moderate chain length, or any combination thereof.

Illustrative Embodiment 13. The method of illustrative embodiment 10, wherein the plasticizer includes polyethylene glycol.

Illustrative Embodiment 14. The method of any of illustrative embodiments 1-13, wherein the method further comprises: preparing the liquid by contacting the binder and the flavorant to a carrier.

Illustrative Embodiment 15. The method of illustrative embodiment 14, wherein the carrier includes water, ethanol, methanol, acetone, propylene glycol, or any combination thereof.

Illustrative Embodiment 16. The method of any of illustrative embodiments 1-15, wherein the substrate includes paper.

Illustrative Embodiment 17. The method of any of illustrative embodiments 1-16, wherein the substrate is fully dissolvable in an aqueous solution.

Illustrative Embodiment 18. The method of any of illustrative embodiments 1-17, wherein the substrate includes polyurethane fibers.

Illustrative Embodiment 19. The method of any of illustrative embodiments 1-18, wherein the substrate is nonwoven.

Illustrative Embodiment 20. The method of any of illustrative embodiments 1-19, wherein the substrate includes a mesh.

Illustrative Embodiment 21. The method of any of illustrative embodiments 1-20, wherein the oral product includes an oral pouch product and the substrate is incorporated into or defines the oral pouch product.

Illustrative Embodiment 22. The method of illustrative embodiment 21, wherein the oral pouch product supports a filler.

Illustrative Embodiment 23. The method of illustrative embodiment 22, wherein the oral pouch product encases the filler.

Illustrative Embodiment 24. The method of any of illustrative embodiments 22-23, wherein the flavorant is a first flavorant and the filler includes a second flavorant, the first and second flavorants being the same.

Illustrative Embodiment 25. The method of any of illustrative embodiments 22-23, wherein the flavorant is a first flavorant and the filler includes a second flavorant, the first and second flavorants being different.

Illustrative Embodiment 26. The method of any of illustrative embodiments 22-25, wherein the binder is a first binder and the filler includes a second binder, the first and second binders being the same.

Illustrative Embodiment 27. The method of any of illustrative embodiments 22-23, wherein the binder is a first binder and the filler includes a second binder, the first and second binders because different.

Illustrative Embodiment 28. The method of any of illustrative embodiments 22-27, wherein the liquid further includes a plasticizer.

Illustrative Embodiment 29. The method of illustrative embodiment 28, wherein the plasticizer is a first plasticizer and the filler includes a second plasticizer, the first and second plasticizers being the same.

Illustrative Embodiment 30. The method of illustrative embodiment 28, wherein the plasticizer is a first plasticizer and the filler includes a second plasticizer, the first and second plasticizers being different.

Illustrative Embodiment 31. The method of any of illustrative embodiments 22-30, wherein the filler includes nicotine.

Illustrative Embodiment 32. The method of illustrative embodiment 31, wherein the filler further includes tobacco.

Illustrative Embodiment 33. The method of illustrative embodiment 32, wherein the filler includes less than or equal to about 5 weight percent of the tobacco.

Illustrative Embodiment 34. The method of any of illustrative embodiments 1-33, wherein the method further comprises: cutting the substrate to a desired shape and size for the oral product.

Illustrative Embodiment 35. The method of illustrative embodiment 34, wherein the cutting occurs prior to the contacting.

Illustrative Embodiment 36. The method of illustrative embodiment 34, wherein the cutting occurs after the contacting.

Illustrative Embodiment 37. The method of any of illustrative embodiments 1-36, wherein the substrate defines one or more cavities, and the method further comprises: filling the one or more cavities.

Illustrative Embodiment 38. The method of illustrative embodiment 37, wherein the filling of the one or more cavities occurs before the contacting.

Illustrative Embodiment 39. The method of illustrative embodiment 37, wherein the filling of the one or more cavities occurs after the contacting.

Illustrative Embodiment 40. The method of illustrative embodiment 37, wherein the method further comprises: folding the substrate, sealing the substrate, or a combination of folding and sealing the substrate to define the one or more cavities.

Illustrative Embodiment 41. The method of illustrative embodiment 40, wherein the folding of the substrate, the sealing of the substrate, or the combination of folding and sealing of the substrate occurs before the contacting.

Illustrative Embodiment 42. The method of illustrative embodiment 40, wherein the folding of the substrate, the sealing of the substrate, or the combination of folding and sealing of the substrate occurs after the contacting.

Illustrative Embodiment 43. The method of any of illustrative embodiments 1-42, wherein air flow in the fluidized bed reactor during the contacting is greater than or equal to about 250 rpm to less than or equal to about 290 rpm.

Illustrative Embodiment 44. The method of any of illustrative embodiments 1-43, wherein a first inlet air temperature during the contacting is greater than or equal to about 50 °C to less than or equal to about 70 °C.

Illustrative Embodiment 45. The method of illustrative embodiment 44, wherein a second inlet air temperature during at least a portion of the drying is greater than or equal to about 35 °C to less than or equal to about 70 °C.

Illustrative Embodiment 46. The method of any of illustrative embodiments 1-45, wherein the contacting occurs for a first time period, the first time period being greater than or equal to about 5 minutes to less than or equal to about 15 minutes.

Illustrative Embodiment 47. The method of illustrative embodiment 46, wherein the drying occurs for a second time period beyond the first time period, the second time period being greater than or equal to about 2 minutes to less than or equal to about 15 minutes.

Illustrative Embodiment 48. The method of any of illustrative embodiments 1-47, wherein the contacting includes spraying the liquid, and a spray rate during the contacting is greater than or equal to about 0.1 g/min to less than or equal to about 3 g/min.

Illustrative Embodiment 49. The method of any of illustrative embodiments 1-48, wherein an atomization air pressure during the contacting is greater than or equal to about 68.9 kPa to less than or equal to about 172.3 kPa.

Illustrative Embodiment 50. The method of any of illustrative embodiments 1-49, wherein the method further comprises: introducing the liquid into the fluidized bed reactor.

Illustrative Embodiment 51. The method of any of illustrative embodiments 1-50, wherein the method further comprises: introducing the substrate into the fluidized bed reactor.

Illustrative Embodiment 52. The method of illustrative embodiment 51, wherein the method further comprises: heating the substrate prior to the contacting.

Illustrative Embodiment 53. The method of illustrative embodiment 52, wherein the substrate is heated to a temperature greater than or equal to about 40 °C to less than or equal to about 50 °C.

Illustrative Embodiment 54. The method of any of illustrative embodiments 1-53,wherein a water content of the oral product ranges from about 1 weight percent to about 50 weight percent.

Illustrative Embodiment 55. The method of illustrative embodiment 54, wherein the water content ranges from about 1 weight percent to about 10 weight percent.

Illustrative Embodiment 56. The method of illustrative embodiment 54, wherein the water content ranges from about 10 weight percent to about 20 weight percent.

Illustrative Embodiment 57. The method of illustrative embodiment 54, wherein the water content is greater than about 20 weight percent.

Illustrative Embodiment 58. The method of illustrative embodiment 54, wherein the water content is greater than about 30 weight percent.

Illustrative Embodiment 59. An oral product comprising one or more flexible, solid layers as prepared by the method of any of illustrative embodiments 1-58.

Illustrative Embodiment 60. The oral product of illustrative embodiment 59, wherein the oral product supports a filler.

Illustrative Embodiment 61. The oral product of illustrative embodiment 60, wherein the filler includes nicotine.

Illustrative Embodiment 62. The oral product of illustrative embodiment 60, wherein the filler includes tobacco.

Illustrative Embodiment 63. The oral product of illustrative embodiment 62, wherein the filler includes less than or equal to about 5 weight percent of the tobacco.

Illustrative Embodiment 64. The oral product of illustrative embodiment 59, wherein a water content of the oral product ranges from about 1 weight percent to about 50 weight percent.

Illustrative Embodiment 65. The oral product of illustrative embodiment 64, wherein the water content range from about 1 weight percent to about 10 weight percent.

Illustrative Embodiment 66. The oral product of illustrative embodiment 64, wherein the water content ranges from about 10 weight percent to about 20 weight percent.

Illustrative Embodiment 67. The oral product of illustrative embodiment 64, wherein the water content is greater than about 20 weight percent.

Illustrative Embodiment 68. The oral product of illustrative embodiment 64, wherein the water content is greater than about 30 weight percent.

Illustrative Embodiment 69. An oral pouch product comprising one or more flexible, solid layers as prepared by the method of any of illustrative embodiments 1-58.

Illustrative Embodiment 70. The oral product of illustrative embodiment 69, wherein the oral product supports a filler.

Illustrative Embodiment 71. The oral product of illustrative embodiment 70, wherein the filler includes nicotine.

Illustrative Embodiment 72. The oral product of illustrative embodiment 70, wherein the filler includes tobacco.

Illustrative Embodiment 73. The oral product of illustrative embodiment 72, wherein the filler includes less than or equal to about 5 weight percent of the tobacco.

Illustrative Embodiment 74. The oral product of illustrative embodiment 69, wherein a water content of the oral product ranges from about 1 weight percent to about 50 weight percent.

Illustrative Embodiment 75. The oral product of illustrative embodiment 74, wherein the water content ranges from about 1 weight percent to about 10 weight percent.

Illustrative Embodiment 76. The oral product of illustrative embodiment 74, wherein the water content ranges from about 10 weight percent to about 20 weight percent.

Illustrative Embodiment 77. The oral product of illustrative embodiment 74, wherein the water content is greater than about 20 weight percent.

Illustrative Embodiment 78. The oral product of illustrative embodiment 74, wherein the water content is greater than about 30 weight percent.

Illustrative Embodiment 79. The oral product of any of illustrative embodiments 70-78, wherein the filler includes an alkaloid.

Illustrative Embodiment 80. The oral product of any of illustrative embodiments 70-89, wherein the filler includes nicotine.

Illustrative Embodiment 81. The oral product of illustrative embodiment 80, wherein the nicotine is tobacco-derived nicotine.

Illustrative Embodiment 82. The oral product of any of illustrative embodiments 80 and 81, wherein the nicotine is synthetic nicotine.

Illustrative Embodiment 83. The oral product of any of illustrative embodiment 80-82, wherein the nicotine is in the form of a nicotine salt.

Illustrative Embodiment 84. The oral product of any of illustrative embodiments 80-83, wherein the nicotine includes free-base nicotine.

Illustrative Embodiment 85. The oral product of any of illustrative embodiments 80-84, wherein the nicotine is in the form of a nicotine ion-exchange resin.

Illustrative Embodiment 86. The oral product of any of illustrative embodiments 80-85, wherein the filler includes the nicotine in an amount ranging from 1 milligram to 12 milligrams.

Illustrative Embodiment 87. The oral product of any of illustrative embodiments 80-86, wherein the filler further includes an antioxidant.

Illustrative Embodiment 88. The oral product of any of illustrative embodiments 80-87, wherein the filling material further includes an oil, and at least a portion of the nicotine is dissolved in the oil.

Illustrative Embodiment 89. The oral product of illustrative embodiment 88, wherein the oil includes a triglyceride.

Illustrative Embodiment 90. The oral product of any of illustrative embodiment 88 and 89, wherein the filler further includes a solid carrier material mixed with the nicotine and the oil.

Illustrative embodiment 91. A method for forming an oral product, the method comprising: contacting a liquid to one or more surfaces of a substrate in a fluidized bed reactor, the liquid including a binder and a flavorant; and drying the liquid in the fluidized bed reactor to form one or more flexible, solid layers, the one or more flexible, solid layers having a moisture content of less than or equal to about 10 weight percent.

Illustrative embodiment 92. The method of illustrative embodiment 91, wherein at least a portion of the drying occurs concurrent with the contacting.

Illustrative embodiment 93. The method of any of illustrative embodiments 91 and 92, wherein the liquid includes greater than or equal to about 0.1 weight % to less than or equal to about 35 weight % of the binder; greater than or equal to about 0.1 weight % to less than or equal to about 50 weight % of the flavorant; or a combination thereof.

Illustrative embodiment 94. The method of any of illustrative embodiments 91-93, wherein the liquid further includes greater than or equal to about 0.1 weight % to less than or equal to about 15 weight % of a plasticizer.

Illustrative embodiment 95. The method of any of illustrative embodiments 91-94, wherein the method further comprises: preparing the liquid by contacting the binder and the flavorant to a carrier.

Illustrative embodiment 96. The method of any of illustrative embodiments 91-95, wherein the substrate is fully dissolvable in an aqueous solution.

Illustrative embodiment 97. The method of any of illustrative embodiments 91-96, wherein the oral product includes an oral pouch product, and the substrate is incorporated into or defines the oral pouch product.

Illustrative embodiment 98. The method of illustrative embodiment 97, wherein the oral pouch product supports a filler.

Illustrative embodiment 99. The method of illustrative embodiment 98, wherein the flavorant is a first flavorant, and the filler includes a second flavorant, the second flavorant being the same as or different from the first flavorant.

Illustrative embodiment 100. The method of any of illustrative embodiments 98 and 99, wherein the binder is a first binder, and the filler includes a second binder, the second binder being the same as or different from the first binder.

Illustrative embodiment 101. The method of any of illustrative embodiments 98-100, wherein the liquid further includes a first plasticizer, and the filler includes a second plasticizer, the second plasticizer being the same as or different from the first plasticizer.

Illustrative embodiment 102. The method of any of illustrative embodiments 91-101, wherein the method further comprises: cutting the substrate to a desired shape and size for the oral product.

Illustrative embodiment 103. The method of any of illustrative embodiments 91-102, wherein the substrate defines one or more cavities, and the method further comprises: filling the one or more cavities.

Illustrative embodiment 104. The method of illustrative embodiment 103, wherein the method further comprises: folding the substrate, sealing the substrate, or a combination of folding and sealing the substrate to define the one or more cavities.

Illustrative embodiment 105. The method of any of illustrative embodiments 91-104, wherein air flow in the fluidized bed reactor during the contacting is greater than or equal to about 250 rpm to less than or equal to about 290 rpm, and a first inlet air temperature during the contacting is greater than or equal to about 50 °C to less than or equal to about 70 °C

Illustrative embodiment 106. The method of illustrative embodiment 105, wherein a second inlet air temperature during at least a portion of the drying is greater than or equal to about 35 °C to less than or equal to about 70 °C.

Illustrative embodiment 107. The method of any of illustrative embodiments 91-106, wherein the contacting includes spraying the liquid, a spray rate during the contacting being greater than or equal to about 0.1 g/min to less than or equal to about 3 g/min.

Illustrative embodiment 108. The method of any of illustrative embodiments 91-107, wherein an atomization air pressure during the contacting is greater than or equal to about 68.9 kPa to less than or equal to about 172.3 kPa.

Illustrative embodiment 109. The method of any of illustrative embodiments 91-108, wherein the method further comprises at least one of: introducing the liquid into the fluidized bed reactor; and introducing the substrate into the fluidized bed reactor.

Illustrative embodiment 200. The method of illustrative embodiment 109, wherein the method further comprises: heating the substrate to a temperature greater than or equal to about 40 °C to less than or equal to about 50 °C prior to the contacting.

What is claimed is:

1. A method for forming an oral product, the method comprising:
contacting a liquid to one or more surfaces of a substrate in a fluidized bed reactor, the liquid including a binder and a flavorant; and
drying the liquid in the fluidized bed reactor to form one or more flexible, solid layers, the one or more flexible, solid layers having a moisture content of less than or equal to about 10 weight percent.

2. The method of claim 1, wherein at least a portion of the drying occurs concurrent with the contacting.

3. The method of claim 1, wherein the liquid includes
greater than or equal to about 0.1 weight % to less than or equal to about 35 weight % of the binder;
greater than or equal to about 0.1 weight % to less than or equal to about 50 weight % of the flavorant; or
a combination thereof.

4. The method of claim 1, wherein the liquid further includes greater than or equal to about 0.1 weight % to less than or equal to about 15 weight % of a plasticizer.

5. The method of claim 1, wherein the method further comprises:
preparing the liquid by contacting the binder and the flavorant to a carrier.

6. The method of claim 1, wherein the substrate is fully dissolvable in an aqueous solution.

7. The method of claim 1, wherein
the oral product includes an oral pouch product, and
the substrate is incorporated into or defines the oral pouch product.

8. The method of claim 7, wherein the oral pouch product supports a filler.

9. The method of claim 8, wherein
the flavorant is a first flavorant, and
the filler includes a second flavorant, the second flavorant being the same as or different from the first flavorant.

10. The method of claim 8, wherein
the binder is a first binder, and
the filler includes a second binder, the second binder being the same as or different from the first binder.

11. The method of claim 8, wherein
the liquid further includes a first plasticizer, and
the filler includes a second plasticizer, the second plasticizer being the same as or different from the first plasticizer.

12. The method of claim 1, wherein the method further comprises:
cutting the substrate to a desired shape and size for the oral product.

13. The method of claim 1, wherein
the substrate defines one or more cavities, and
the method further comprises:
filling the one or more cavities.

14. The method of claim 13, wherein the method further comprises:
folding the substrate, sealing the substrate, or a combination of folding and sealing the substrate to define the one or more cavities.

15. The method of claim 1, wherein
air flow in the fluidized bed reactor during the contacting is greater than or equal to about 250 rpm to less than or equal to about 290 rpm, and
a first inlet air temperature during the contacting is greater than or equal to about 50 °C to less than or equal to about 70 °C.

16. The method of claim 15, wherein a second inlet air temperature during at least a portion of the drying is greater than or equal to about 35 °C to less than or equal to about 70 °C.

17. The method of claim 1, wherein the contacting includes spraying the liquid, a spray rate during the contacting being greater than or equal to about 0.1 g/min to less than or equal to about 3 g/min.

18. The method of claim 1, wherein an atomization air pressure during the contacting is greater than or equal to about 68.9 kPa to less than or equal to about 172.3 kPa.

19. The method of claim 1, wherein the method further comprises at least one of:
introducing the liquid into the fluidized bed reactor; and
introducing the substrate into the fluidized bed reactor.

20. The method of claim 19, wherein the method further comprises:
heating the substrate to a temperature greater than or equal to about 40 °C to less than or equal to about 50 °C prior to the contacting.
